(19) United States
(12) Patent Application Publication
(10) Pub. No.: US 2018/0301034 A1
(43) Pub. Date: Oct. 18, 2018

(54) SERVER DEVICE, VEHICLE CONTROL DEVICE, AND COMMUNICATION DEVICE

(71) Applicant: KYOCERA CORPORATION, Kyoto (JP)

(72) Inventor: Kugo MORITA, Yokohama-shi (JP)

(73) Assignee: KYOCERA CORPORATION, Kyoto (JP)

(21) Appl. No.: 16/015,448

(22) Filed: Jun. 22, 2018

Related U.S. Application Data
(63) Continuation of application No. PCT/JP2016/088567, filed on Dec. 22, 2016.
(60) Provisional application No. 62/387,333, filed on Dec. 23, 2015.

(51) Int. Cl. G08G 1/16; G08G 1/0967

(52) U.S. Cl. CPC G08G 1/164; G08G 1/096725; G08G 1/163; G08G 1/096791; G08G 1/166; G08G 1/096775

(57) ABSTRACT

A server device according to one embodiment performs communication with a plurality of vehicles through a network, the server device comprising a processor. The processor is configured to: if the plurality of vehicles include a first vehicle traveling by automatic driving and a second vehicle traveling by manual driving, acquire driving information of the second vehicle, assign, to the first vehicle, a road area to which the first vehicle should travel by the automatic driving, based on the driving information, so that contact between the first vehicle and the second vehicle does not occur.

### CROSS-REFERENCE TO RELATED APPLICATION

The present application is a continuation based on PCT Application No. PCT/JP2016/088567 filed on Dec. 22, 2016, which claims the benefit of U.S. Patent Provisional Application No. 62/387,333 (filed on Dec. 23, 2015), the entire contents of which are incorporated herein by reference.

### FIELD

The present invention relates to a server device, a vehicle control device, and a communication device for a road transportation system.

### BACKGROUND

Driving of an automobile is basically carried out by using an accelerator, a brake, and a steering wheel. A driver drives an automobile by controlling them. When considering traveling to a destination to which you are going for the first time, the driver has conventionally confirmed and memorized a route to the destination on a map in advance, and then performed driving to the destination based on the memory. Alternatively, a driver had a passenger see a map, and drove to a destination according to the instructions of the passenger.

On the other hand, at present, a driver can drive to a destination according to instructions of a navigation system (see Patent Literature 1: JP 6-194181 A). The navigation system searches for a route to a destination set in advance on map data, which is converted into digital data, from current position information acquired by a position information acquisition means such as a Global Navigation Satellite System (GNSS). Based on the search result, the navigation system sequentially issues an instruction corresponding to the current position to the driver. The driver can arrive at the destination by driving according to the instruction. Therefore, the driver can arrive at the destination, without spending effort to grasp the driving route in advance or without a passenger who has to spend effort to check the map and give the instruction.

However, until now, it was necessary for a person having a driving skill to board a vehicle in the first place. Regarding this problem, recent research has been actively conducted on automatic driving (see Non Patent Literature 1: Shinomura Rinko “DI-1-2 Recent Trends in Automatic Driving and Driving Assist Technology” 2014 The Institute of Electronics, Information and Communication Engineers General Convention).

The automatic driving is a technique for autonomously driving a vehicle to a destination by successively grasping circumstances of the vehicle by various sensors such as a radar and/or a camera mounted on the vehicle, without intervention of a human's hand. In this manner, the passenger can move to the destination simply by setting the destination, without requiring the effort of the act of driving itself, and furthermore, without requiring the effort of learning the driving skill.

On the other hand, there is traffic congestion as a problem in road traffic. There are various causes of traffic congestion, for example, “traffic congestion (1) caused by a speed decreasing unintentionally as a result of keeping stepping on the same way without noticing a change to an uphill road”, “traffic congestion (2) where a vehicle (right turn vehicle) attempting to make a right turn is blocked by an oncoming vehicle and waits for a right turn, and a following vehicle of the right turn vehicle cannot pull out the right turn vehicle”, “traffic congestion (3) due to signal waiting”, “traffic congestion (4) caused by temporary concentration of vehicles on narrow roads”, and the like. As a mechanism of occurrence of such traffic congestion, it is considered that traffic congestion is caused by a decrease or stop of the speed of the vehicle traveling at the head due to some causes.

The above-mentioned traffic congestion (1) is a traffic congestion caused because the driver did not notice the change of situation due to visual misrecognition and operated as before. Therefore, in automatic driving that drives while checking a vehicle speed at any time, there is a possibility that traffic congestion (1) will be reduced.

On the other hand, at present, road conditions are collected with vehicle sensors installed on the roadside, and road information such as congestion based on this information is provided to each vehicle through FM multiplex broadcasting or road-to-vehicle communication such as beacon (VICS (registered trademark): Vehicle Information and Communication System). Each vehicle can select a route avoiding a congested road by considering the route to the destination based on the road information.

In addition, vehicle-to-vehicle (V2V) communication that directly transmits and receives information between vehicles has recently been studied. In the vehicle-to-vehicle communication, for example, it is thought that vehicle information such as the speed and position of the vehicle can be transmitted and received. Therefore, even if the speeds of some preceding vehicles are lowered for some reasons, it is possible to immediately receive information on the speed reduction from the preceding vehicles and warn the driver. Therefore, it is considered that the driver can respond to the speed reduction before the speed reduction of the immediately preceding vehicle occurs.

### SUMMARY

A server device according to one embodiment performs communication with a plurality of vehicles through a network, the server device comprising a processor. The processor is configured to: if the plurality of vehicles include a first vehicle traveling by automatic driving and a second vehicle traveling by manual driving, acquire driving information of the second vehicle, assign, to the first vehicle, a road area to which the first vehicle should travel by the automatic driving, based on the driving information, so that contact between the first vehicle and the second vehicle does not occur.

A vehicle control device according to one embodiment is provided in a vehicle and controls the vehicle. The vehicle control device comprises a communication unit configured to perform communication with a server device through a network; a processor configured to notify the server device of driving information of the vehicle if the vehicle travels by manual driving; and a control unit configured to restrict traveling by the manual driving, based on an instruction from the server device.

A communication device according to one embodiment is provided in a vehicle. The communication device comprises a communication unit configured to perform communication with a server device through a network. If the vehicle travels by the manual driving, the communication unit may transmit driving information of the vehicle to the server device. The communication unit may receive, from the server device, an instruction for restricting traveling by the manual driving.

### BRIEF DESCRIPTION OF DRAWINGS

FIG. 1 is a configuration diagram according to an embodiment.

FIG. 2 is a diagram illustrating an example of a configuration of a manual driving requesting vehicle according to an embodiment.

FIG. 3 is a diagram illustrating an example of a configuration of a route assignment server according to an embodiment.

FIG. 4 is a diagram illustrating an example of a configuration of a charging server according to an embodiment.

FIG. 5 is a diagram illustrating an example of a configuration of a weather information server according to a modification example.

FIG. 6 is a diagram illustrating an example of a flow of movement setting of an automatically driven vehicle according to an embodiment.

FIG. 7 is a diagram illustrating an example of a flowchart of updating a vehicle information storage unit according to an embodiment.

FIG. 8 illustrates an example of a processing flowchart in a vehicle at the time of measuring environmental information according to an embodiment.

FIG. 9 illustrates an example of a processing flowchart of a route assignment server at the time of receiving environmental information and weather information according to an embodiment.

FIG. 10 illustrates an example of a processing flowchart of a route assignment server at the time of updating a weather information storage unit according to an embodiment.

FIGS. 11A to 11D are diagrams illustrating road area occupied for each height according to an embodiment.

FIGS. 12A to 12B are flowcharts illustrating setting of a minute section according to an embodiment.

FIGS. 13A to 13B are diagrams illustrating reception of a synchronization reference signal according to an embodiment.

FIG. 14 illustrates an example of a flowchart of a vehicle upon a driving request according to an embodiment.

FIG. 15 illustrates an example of a flowchart of a route assignment server upon a driving request according to an embodiment.

FIG. 16 is a diagram illustrating an example of a flow of manual driving setting according to an embodiment.

FIGS. 17A to 17B are diagrams illustrating examples of flows of manual driving determination by driving qualification according to an embodiment.

FIG. 18 is a diagram illustrating an example of a flow of manual driving determination by insurance card information according to an embodiment.

FIG. 19 is a diagram illustrating an example of a flow of manual driving determination by physical information according to an embodiment.

FIG. 20 illustrates an example of a flowchart of communication path securing processing according to an embodiment.

FIG. 21 is a diagram illustrating an example of a travel setting according to an embodiment.

FIG. 22 illustrates an example of a processing flowchart at the time of manual driving of a vehicle according to an embodiment.

FIG. 23 is a diagram illustrating an instruction delay time according to an embodiment.

FIGS. 24A to 24B are diagrams illustrating safety distance according to an embodiment.

FIGS. 25A to 25D are diagrams illustrating safety distance according to an embodiment.

FIG. 26 is a diagram illustrating a driving restriction (speed limit) according to an embodiment.

FIG. 27 is a diagram illustrating a driving restriction (acceleration limit) according to an embodiment.

FIG. 28 is a diagram illustrating a driving restriction (actual steering angle limit) according to an embodiment.

FIGS. 29A to 29B are diagrams illustrating area restriction according to an embodiment.

FIGS. 30A to 30C are diagrams illustrating an embodiment.

FIG. 31 is a diagram illustrating an example of a flow when an emergency vehicle approaches according to an embodiment.

FIG. 32 illustrates an example of a flowchart of a route assignment server of visual recognition unnecessary processing according to an embodiment.

FIG. 33 illustrates an example of a flowchart of a manually driven vehicle of visual recognition unnecessary processing according to an embodiment.

FIGS. 34A to 34B are diagrams illustrating visual recognition unnecessary processing according to an embodiment.

FIGS. 35A to 35C are diagrams illustrating examples of visual recognition unnecessary processing according to an embodiment.

FIGS. 36A to 36B are diagrams illustrating examples of arrangement of a false wall according to an embodiment.

FIG. 37 is a diagram illustrating manual driving determination by a driving area according to an embodiment.

FIG. 38 is a diagram illustrating manual driving determination by a minute time period according to an embodiment.

### DESCRIPTION OF EMBODIMENTS

### Overview of Embodiments

As described above, the automatic driving is a technique in which individual vehicles autonomously determine the surroundings based on information acquired by sensors held in the individual vehicles and perform driving. However, for example, in the case of the traffic congestion (2), the oncoming vehicle is not necessarily limited to the right turn vehicle. Even when there is the vehicle that gives way to the road, if the right turn vehicle cannot determine that a safe right turn is possible, the right turn vehicle will not turn to the right. Also, in the vehicle-to-vehicle communication, even when one oncoming vehicle urges the right turn to the right turn vehicle, if another oncoming vehicle makes a different determination, the right turn vehicle cannot determine that a safe right turn is possible and does not turn to the right. For example, in the case of the traffic congestion (4), when avoiding the traffic congestion based on traffic congestion information by the road-to-vehicle communication, the respective vehicles perform traffic congestion avoidance behaviors in the same way, and thus the traffic congestion place moves to another place. Therefore, even in the automatic driving, it can be said that there is a problem of traffic congestion.

On the other hand, when considering the passage of an emergency vehicle such as an ambulance, no matter how heavy traffic, each vehicle makes the way to pass the emergency vehicle, and thus the emergency vehicle passes even in the traffic congestion. This means that there is still room on the road, and if a space can be used more effectively, there is a possibility of providing a more comfortable driving environment. In other words, in a current road use, there is a problem that the space cannot be used sufficiently efficiently.

To cope with such a problem, there is provided a transportation system including a vehicle that is connected to communicate with a network in radio communication and performs automatic driving, and a route assignment server that is connected to communicate with the vehicle through the network and calculates a traveling route of the vehicle. The route assignment server assigns a road area occupied by the vehicle for each minute time period to a destination of the vehicle, based on the destination from the vehicle, vehicle information, and road information. Each vehicle can make effective use of a road space by automatically driving the assigned road area at a synchronized timing based on a synchronization signal.

However, while there is a demand for a vehicle as a moving means, some people have demands on the act of driving themselves. In the proposal, such a request cannot be satisfied.

A server device (route assignment server 200) according to embodiments performs communication with a plurality of vehicles through a network (network 500), the server device comprising a processor (processor 200). The processor is configured to: if the plurality of vehicles include a first vehicle (vehicle 100) traveling by automatic driving and a second vehicle (manual driving requesting vehicle 160) traveling by manual driving, acquire driving information of the second vehicle, assign, to the first vehicle, a road area to which the first vehicle should travel by the automatic driving, based on the driving information, so that contact between the first vehicle and the second vehicle does not occur.

In the server device according to the embodiments, the driving information may include at least one of a position, a speed, acceleration, an actual steering angle, and a vehicle body direction of the second vehicle.

In the server device according to the embodiments, the processor may determine whether to permit the manual driving to the second vehicle. If the processor determines that the manual driving is not permitted, the processor may instruct automatic driving to the second vehicle.

In the server device according to the embodiments, if charging is made for the manual driving, the processor may inquire of another server device (charging server 300) which manages the charging whether it is possible to permit the manual driving to the second vehicle.

In the server device according to the embodiments, the processor may inquire of another server device (driving qualification management server 701, insurance card management server 702) which manages registration information about a driver of the second vehicle whether it is possible to permit the manual driving to the second vehicle. The registration information may include information about at least one of driving qualification and insurance.

In the server device according to the embodiments, the processor may acquire physical information about a physical condition of a driver of the second vehicle from the second vehicle. The processor may determine whether to permit the manual driving to the second vehicle, based on the physical information.

In the server device according to the embodiments, the processor may perform processing for securing a communication resource necessary for communication associated with the manual driving in a base station. If securing the communication resource is impossible, the processor may determine that the manual driving is not permitted to the second vehicle.

In the server device according to the embodiments, the processor may determine whether the second vehicle exists in a danger zone, based on weather information about weather and/or the driving information. If the processor determines that the second vehicle exists in the danger zone, the processor may determine that the manual driving is not permitted to the second vehicle.

In the server device according to the embodiments, if the first vehicle is an emergency vehicle, the processor may determine whether the second vehicle exists in the vicinity of the first vehicle, based on the road area assigned to the first vehicle and the driving information. If the processor determines that the second vehicle exists in the vicinity of the first vehicle, the processor may determine that the manual driving is not permitted to the second vehicle.

In the server device according to the embodiments, the processor may determine whether an oncoming vehicle exists in a travelable area of the second vehicle. If the processor determines that the oncoming vehicle exists in the travelable area, the processor may determine that the manual driving is not permitted to the second vehicle.

In the server device according to the embodiments, the processor may estimate synchronization accuracy corresponding to a position of the second vehicle, based on the position of the second vehicle. If the processor determines that the synchronization accuracy is low, the processor may determine that the manual driving is not permitted to the second vehicle.

In the server device according to the embodiments, the processor may assign, to the second vehicle, a road area that permits traveling by the manual driving. The processor may assign, to the first vehicle, a road area outside the road area assigned to the second vehicle.

In the server device according to the embodiments, if an image output unit (output unit 104) is provided on the line of sight of a driver of the second vehicle, the processor may notify the second vehicle of information for causing the image output unit to display an image corresponding to a visual recognition unnecessary area that the driver of the second vehicle does not need to visually recognize.

In the server device according to the embodiments, the visual recognition unnecessary area may be another vehicle that exists in front of the second vehicle. The image may be a substitute image captured by the other vehicle.

In the server device according to the embodiments, the visual recognition unnecessary area may be a space on a road area where the traveling of the second vehicle is not permitted. The image may be a mask image for hiding the space.

In the server device according to the embodiments, the processor may change a method of displaying the mask image according to a speed of the second vehicle.

A vehicle control device (vehicle control device 160b) according to the embodiments is provided in a vehicle (manual driving requesting vehicle 160) and controls the vehicle. The vehicle control device comprises a communication unit (communication unit 102) configured to perform communication with a server device (route assignment server 200) through a network (network 500); a processor (processor 103) configured to notify the server device of driving information of the vehicle if the vehicle travels by manual driving; and a control unit (automatic driving processor 110, an automatic/manual switching unit 116) configured to restrict traveling by the manual driving, based on an instruction from the server device.

In the server device according to the embodiments, if the manual driving is permitted from the server device, the control unit may control the vehicle to travel by the manual driving. If an instruction is issued from the server device to perform automatic driving, the control unit may control the vehicle to travel by the automatic driving.

In the server device according to the embodiments, the processor may notify the server device of physical information about a physical condition of a driver of the vehicle.

In the server device according to the embodiments further comprise an image output unit (output unit 104) configured to display an image on the line of sight of a driver of the vehicle. The processor may perform processing of causing the image output unit to display an image corresponding to a visual recognition unnecessary area that the driver of the vehicle does not need to visually recognize, based on information from the server device.

A communication device (communication device 160a) according to the embodiments is provided in a vehicle (manual driving requesting vehicle 160). The communication device comprises a communication unit (communication unit 102) configured to perform communication with a server device (route assignment server 200) through a network (network 500). If the vehicle travels by the manual driving, the communication unit may transmit driving information of the vehicle to the server device. The communication unit may receive, from the server device, an instruction for restricting traveling by the manual driving.

According to an embodiment, it is possible to coexist with the automatically driven vehicle and the manually driven vehicle and to make it possible to effectively use the road space while responding to a request that a driver himself drives.

### Embodiment

An embodiment will be described below.

(System Configuration)

FIG. 1 is a diagram illustrating a configuration of a system according to an embodiment.

As illustrated in FIG. 1, a vehicle 100 and a manual driving requesting vehicle 160 radio-communicate with a base station 400. The base station 400, a route assignment server 200, a charging server 300, and a weather information server 600 communicate with one another through a network 500.

The vehicle 100 and the manual driving requesting vehicle 160 transmit a request for traveling (travel request) to the route assignment server 200 through the base station 400 and the network 500. The route assignment server 200 calculates the route assignment of each vehicle 100 based on the travel request and the previously received travel request of another vehicle 100. The route assignment server 200 transmits the route assignment to each vehicle 100 as necessary.

The route assignment server 200 acquires weather information from the weather information server 600. The route assignment server 200 acquires vehicle information from the vehicle 100 and the manual driving requesting vehicle 160. The route assignment server 200 acquires environmental information measured by the vehicle 100 and the manual driving requesting vehicle 160. If the manual driving requesting vehicle 160 travels by manual driving, the manual driving requesting vehicle 160 always notifies the route assignment server 200 of the vehicle information including driving information such as a position, a speed, an acceleration, an actual steering angle, a vehicle body direction. The route assignment server 200 calculates route assignment of each vehicle by taking into account the notified weather information, vehicle information, and environmental information.

The vehicle 100 is a vehicle having an automatic driving function. The vehicle 100 travels by automatic driving according to the received route assignment. The manual driving requesting vehicle 160 is a vehicle that desires the manual driving, and if the manual driving is permitted, the vehicle is driven by a passenger. If the manual driving is not permitted, the manual driving requesting vehicle 160 travels as an automatically driven vehicle by the automatic driving according to the received route assignment in the same manner as the vehicle 100.

Charging may be made for the route assignment. In this case, the route assignment server 200 determines whether charging is generated for a travel request from the vehicle 100. When the route assignment server 200 determines that the charging is generated, the route assignment server 200 notifies the vehicle 100 of that effect. The vehicle 100 notifies the route assignment server 200 of approval or rejection of the charging. If the notification of the vehicle 100 is the approval, the route assignment server 200 notifies the charging server 300 of the approval of the charging and fixes the route assignment.

If the request for manual driving is received from the manual driving requesting vehicle 160, the route assignment server 200 confirms the payment ability of the charging destination associated with the request for manual driving to the charging server 300. If there is no payment ability, the route assignment server 200 does not permit the manual driving. If there is the payment ability, the route assignment server 200 requests the base station 400 or the server controlling the base station 400 to secure the occupied radio communication resource for the vehicle after the completion of the payment. If the resource for radio communication cannot be secured, the route assignment server 200 does not permit the manual driving. If the resource for radio communication can be secured, the route assignment server 200 permits the manual driving. The route assignment server 200 confirms the payment ability to the charging destination at short time intervals and does not permit the manual driving at the time when it is determined that there is no payment ability.

(Configuration of Vehicle)

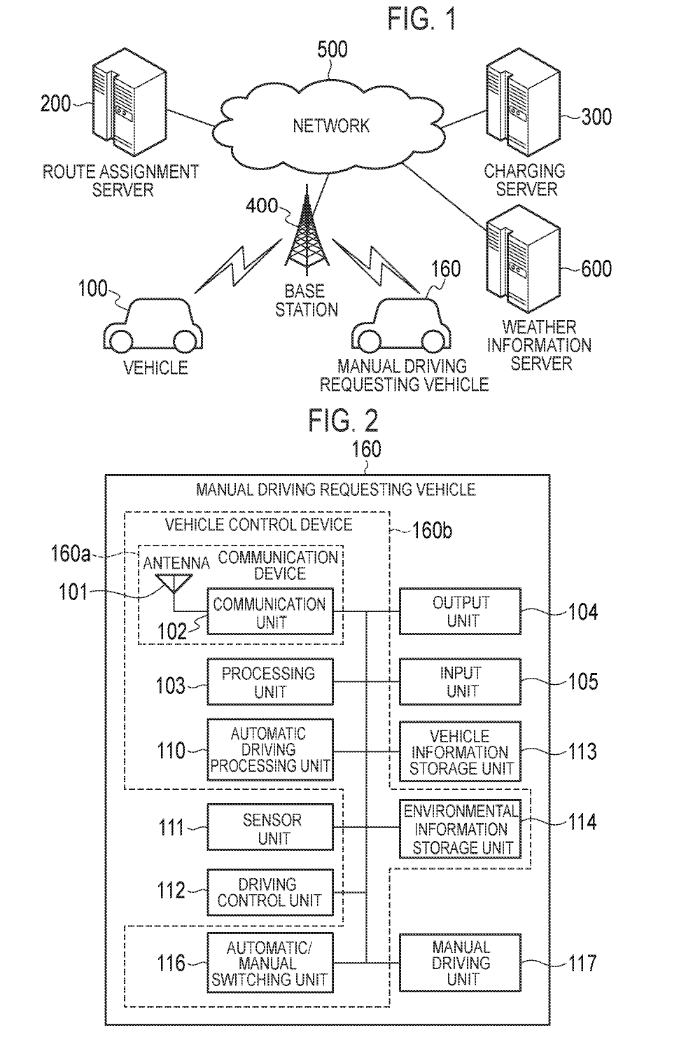

FIG. 2 is a diagram illustrating an example of the configuration of the manual driving requesting vehicle 160.

As illustrated in FIG. 2, the manual driving requesting vehicle 160 includes an antenna 101, a communication unit 102, a processing unit 103, an output unit 104, an input unit 105, an automatic driving processing unit 110, a sensor unit 111, a driving control unit 112, a vehicle information storage unit 113, an environmental information storage unit 114, an automatic/manual switching unit 116, and manual driving unit 117. The communication unit 102 is radio-connected to the base station 400 through the antenna 101. The output unit 104 outputs an image and/or a sound to passengers (a driver and a fellow passenger). The input unit 105 receives a voice input from a passenger and an operation input of a touch panel or the like. The automatic driving processing unit 110 performs processing in automatic driving. The sensor unit 111 includes a sensor for measurement outside the vehicle, such as a camera and a radar, and a sensor for measurement inside the vehicle, such as a vehicle speed, a position, and a weight. The driving control unit 112 controls the traveling of the vehicle based on driving operations such as an accelerator, a brake, and a steering. The vehicle information storage unit 113 stores the vehicle information including information about objects (components) constituting the vehicle, such as vehicle type, history of components, software version information, and the like. The environmental information storage unit 114 stores the environmental information measured by sensors. The automatic/manual switching unit 116 switches between the automatic driving and the manual driving. The manual driving unit 117 is an interface operated by the passenger, such as an access pedal, a brake pedal, a steering wheel, a shift knob, and the like handled when the passenger (driver) manually drives.

The antenna 101 and the communication unit 102 constitute a communication device 160a provided in the vehicle. The communication device 160a may further include a processing unit 103. The communication device 160a, the processing unit 103, the automatic driving processing unit 110, the vehicle information storage unit 113, the environmental information storage unit 114, and the automatic/manual switching unit 116 constitute a vehicle control device 160b that controls the vehicle. The vehicle control device 160b may further include an output unit 104 and an input unit 105. The operation of the manual driving requesting vehicle 160 described below is controlled by the vehicle control device 160b.

The passenger inputs, to the input unit 105, a request such as movement to a destination, air conditioning, or music. If the request is a travel request, the processing unit 103 transmits the travel request to the route assignment server 200 through the communication unit 102. In the case of a request other than the travel request, the processing unit 103 activates a corresponding function in the vehicle. The processing unit 103 receives a notification from the route assignment server 200 through the communication unit 102. When the notification is a notification related to automatic driving, the processing unit 103 notifies the automatic driving processing unit 110 of this notification. When the notification includes information that needs to be notified to the passenger, the processing unit 103 outputs the information to the passenger through the output unit 104.

The automatic driving processing unit 110 issues instructions for an accelerator, a brake, and a steering to the driving control unit 112, based on the information about the automatic driving received from the processing unit 103 and the acquisition result from the sensor unit 111, and controls the traveling of the vehicle. The automatic driving processing unit 110 notifies the processing unit 103 of a part or the whole of the measurement result acquired by the sensor unit 111. The processing unit 103 notifies a part of the measurement result, for example, a road surface condition and/or a vehicle body condition, to the route assignment server 200 through the communication unit 102.

The vehicle information storage unit 113 holds, for example, a model number of the vehicle, a replacement history of the components, an abrasion condition, a model number of the software of the automatic driving processing, a version, and the like as the information about the components constituting the vehicle. An automatic driving processing unit 110 transmits, to the route assignment server 200, the vehicle information held in the vehicle information storage unit 113 according to the instruction of the route assignment server 200.

The environmental information storage unit 114 stores environmental information around the vehicle, such as a temperature, a pressure, a humidity, a wind direction, a wind pressure, a rainfall, a snow cover, a road surface condition (irregularity information, flooding, snow cover, frozen state), an image, a video, together with a measurement time and a measurement position. The automatic driving processing unit 110 measures each environmental information at each timing according to the instruction of the route assignment server 200, and holds the environmental information in the environmental information storage unit 114. The automatic driving processing unit 110 transmits the environmental information stored in the environmental information storage unit 114 to the route assignment server 200 based on the instructed timing.

The vehicle 100 and the manual driving requesting vehicle 160 are synchronized with a timing based on a signal from a GNSS and a signal from the base station 400. The vehicle 100 and the manual driving requesting vehicle 160 notify the route assignment server 200 of the level and position of synchronization. The vehicle 100 and the manual driving requesting vehicle 160 confirm the position on the road based on the position information by the GNSS and the result of measuring the road with the sensor. The vehicle 100 and the manual driving requesting vehicle 160 travel at the designated position. When the road is measured by using the sensor, the vehicle 100 and the manual driving requesting vehicle 160 detect and grasps a painted line on the road, such as a shoulder, a median strip, or a white line, by using a camera, a distance sensor or the like. Alternatively, at the time of creating the road, numerous magnetic substances are mixed into the asphalt or cement and spread on the road. The vehicle 100 and the manual driving requesting vehicle 160 store a combination of magnetic substance arrangement pattern and position. At the time of traveling, the vehicle 100 and the manual driving requesting vehicle 160 read the arrangement pattern of the magnetic substances around the lower portion of the vehicle body of the vehicle 100 and the manual driving requesting vehicle 160 by using the sensor. The vehicle 100 and the manual driving requesting vehicle 160 specify the position thereof based on the read arrangement pattern.

If the passenger desires the manual driving, the passenger inputs the desired manual driving setting to the input unit 105. The processing unit 103 transmits a request (manual driving request) including the input manual driving setting to the route assignment server 200. When a response to the request for manual driving is received from the route assignment server 200, the processing unit 103 outputs response contents to the passenger through the output unit 104. If the response contents are the permission of the manual driving, the automatic/manual switching unit 116 gradually switches the ratio between the control by the automatic driving processing unit 110 and the control by the manual driving unit 117 from the automatic driving processing unit 110 to the manual driving unit 117. The passenger performs the driving operation in the manual driving unit 117. The input in the manual driving unit 117 is notified to the driving control unit 112 through the automatic/manual switching unit 116 and controls the traveling of the vehicle.

In the configuration of the vehicle that does not have the manual driving function, the automatic/manual switching unit 116 and the manual driving unit 117 are removed from the configuration of the manual driving requesting vehicle 160. That is, in the configuration of the vehicle 100, the automatic/manual switching unit 116 and the manual driving unit 117 are removed from the configuration of the manual driving requesting vehicle 160.

In addition, if the passenger performs the manual driving, an image, a voice, or the like for calling attention may be output through the output unit 104 so as not to cause dangerous driving (for example, unreasonable route change or the like). Therefore, it is possible to reduce the load of the route assignment of the route assignment server with respect to other vehicles that perform automatic driving.

(Configuration of Route Assignment Server)

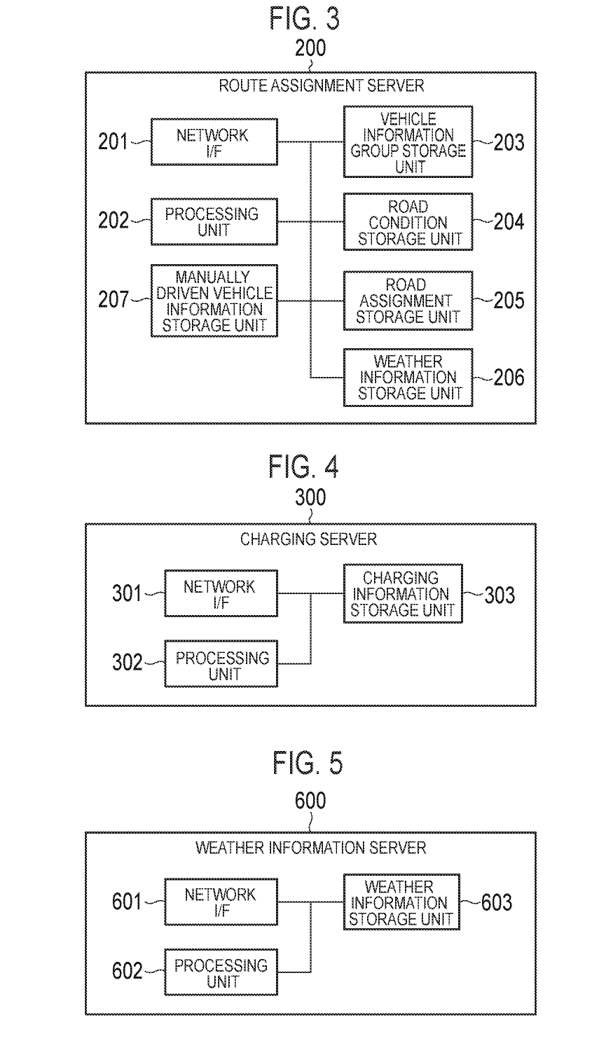

FIG. 3 is a diagram illustrating an example of the configuration of the route assignment server 200.

As illustrated in FIG. 3, the route assignment server 200 includes a network I/F unit 201, a processing unit 202, a vehicle information group storage unit 203, a manually driven vehicle information storage unit 207, a road condition storage unit 204, a road assignment storage unit 205, and a weather information storage unit 206. The network I/F unit 201 is connected so as to communicate with the network 500. The vehicle information group storage unit 203 stores information about each vehicle. The manually driven vehicle information storage unit 207 stores information about each manual driving requesting vehicle. The road condition storage unit 204 stores the road surface condition of the road and the like. The road assignment storage unit 205 stores the assignment of the road to the vehicle. The weather information storage unit 206 stores weather information.

The processing unit 202 performs communication with the vehicle 100 and the manual driving requesting vehicle 160, the charging server 300, and the weather information server 600 through the network I/F unit 201. The processing unit 202 stores, in the vehicle information group storage unit 203, the travel request from the vehicle 100 and/or the vehicle condition. The processing unit 202 stores the travel request from the manual driving requesting vehicle 160 and/or the vehicle condition in the manually driven vehicle information storage unit 207.

The processing unit 202 stores, in the road condition storage unit 204, the road surface conditions acquired from the vehicle 100 and the manual driving requesting vehicle 160, and/or a road management device disposed on the road side.

The processing unit 202 acquires weather information from the weather information server 600, acquires environmental information from the vehicle 100 and the manual driving requesting vehicle 160, and stores the acquired information in the weather information storage unit 206.

The processing unit 202 performs the assignment of the road (road area) based on the information held in the vehicle information group storage unit 203, the information held in the manually driven vehicle information storage unit 207, the information held in the road condition storage unit 204, and the weather information and the environmental information held in the weather information storage unit 206. The processing unit 202 stores the road assignment result (road assignment) in the road assignment storage unit 205. The processing unit 202 notifies the vehicle 100 and the manual driving requesting vehicle 160 of the road assignment in the vehicle 100 and the manual driving requesting vehicle 160 through the network I/F 201. The road assignment notified to the vehicle 100 and the manual driving requesting vehicle 160 is route assignment information (road assignment information) composed of a road area assigned to only one vehicle in the vehicle 100 and a minute period (minute time period). The minute period is a period (for example, 1 ms) that becomes controllable based on the synchronization of the vehicle 100 and the manual driving requesting vehicle 160.

If there is a priority in the vehicle, the processing unit 202 first assigns the road area with respect to the traveling route of the vehicle with high priority. In the case of vehicles having the same priority, the processing unit 202 compares the traveling routes of the respective vehicles. As a result of the comparison, if the vehicle travels on the same route section, the processing unit 202 assigns the road area from the vehicle 100 and the manual driving requesting vehicle 160 traveling ahead in time on the same route.

The route assignment server 200 (processing unit 202) determines a minute period of the position based on the accuracy of synchronization corresponding to the position acquired from the vehicle 100 and the manual driving requesting vehicle 160. The accuracy of the synchronization timing if the broadcast signal of the base station 400 can be received is different from the accuracy of the synchronization timing if only the GNSS can be received. For example, in the case based on the broadcast signal of the base station 400, the route assignment server 200 sets the minute period to be small (for example, 1 ms). On the other hand, in the case based on only the GNSS, the route assignment server 200 sets the minute period to be large (for example, 1 sec). If the length of the minute period is switched, the route assignment server 200 sets the length of the minute period to gradually change.

If the route assignment server 200 (the processing unit 202) receives the notification accompanying the abnormality of the vehicle 100 and/or the manual driving requesting vehicle 160, the processing unit 202 determines the destination of the vehicle based on the notification that there is the abnormality. The route assignment server 200 performs the route assignment processing according to the determined destination of the vehicle. In addition, the route assignment server 200 requests repair. According to the situation, the route assignment server 200 boards the passenger of the vehicle that made the notification of the abnormality to a nearby traveling vehicle traveling in the vicinity of a vehicle that has issued the notification of abnormality, requests to operate as an evacuation vehicle to evacuate the site, and notifies a transfer instruction or the like accompanying this.

According to the situation, the route assignment server 200 (the processing unit 202) requests the nearby traveling vehicle of the vehicle notifying the abnormality to guide the vehicle that made the notification. In addition, the base station 400 or the control server of the base station 400 is requested to secure the communication means between the vehicle which issued the notification indicating the abnormality and the vehicle which is guided, and the permitted communication means is notified to the vehicle that issued the notification and the vehicle to be guided.

If the notification of the parked/stopped vehicle is received, the processing unit 202 determines the presence or absence of a future traffic hindrance based on the notification of the parked/stopped vehicle and the road assignment of the road assignment storage unit 205. If it is determined that the traffic hindrance occurs, the processing unit 202 determines the destination of the parked/stopped vehicle and performs the route assignment processing.

(Configuration of Charging Server)

FIG. 4 is a diagram illustrating an example of the configuration of the charging server 300.

As illustrated in FIG. 4, the charging server 300 includes a network I/F unit 301, a processing unit 302, and a charging information storage unit 303. The network I/F unit 301 is connected to communicate with the network 500. The charging information storage unit 303 stores charging information about the vehicle 100 and the manual driving requesting vehicle 160.

The processing unit 302 receives a charging approval message through the network I/F 301. The processing unit 302 holds the charging approval message in the charging information storage unit 303. In addition, the processing unit 302 receives a message of performance information indicating that the payment of the charging has been fulfilled. The processing unit 302 determines the charging according to the message contents of the performance information corresponding to the charging information in the charging information storage unit 303. The processing unit 302 performs the processing of the information of the charging information storage unit 303 based on the payment request. If the processing unit 302 receives the payment instruction, the processing unit 302 performs payment processing according to the payment instruction. The processing unit 302 returns the situation of the payment processing to the transmission source through the network I/F unit 301 as a response to the payment instruction.

(Configuration of Weather Information Server)

FIG. 5 is a diagram showing an example of the configuration of the weather information server 600.

As illustrated in FIG. 5, the weather information server 600 includes a network I/F 601, a processing unit 602, and a weather information storage unit 603. The network I/F 601 is connected so as to communicate with the network 500. The weather information storage unit 603 stores weather information.

The processing unit 602 receives a weather information request through the network I/F 601. The processing unit 602 returns the weather information held in the weather information storage unit 603 in response to the weather information request. Alternatively, if there is weather information to be transmitted, the processing unit 602 broadcasts the weather information.

(Flow of Movement Setting)

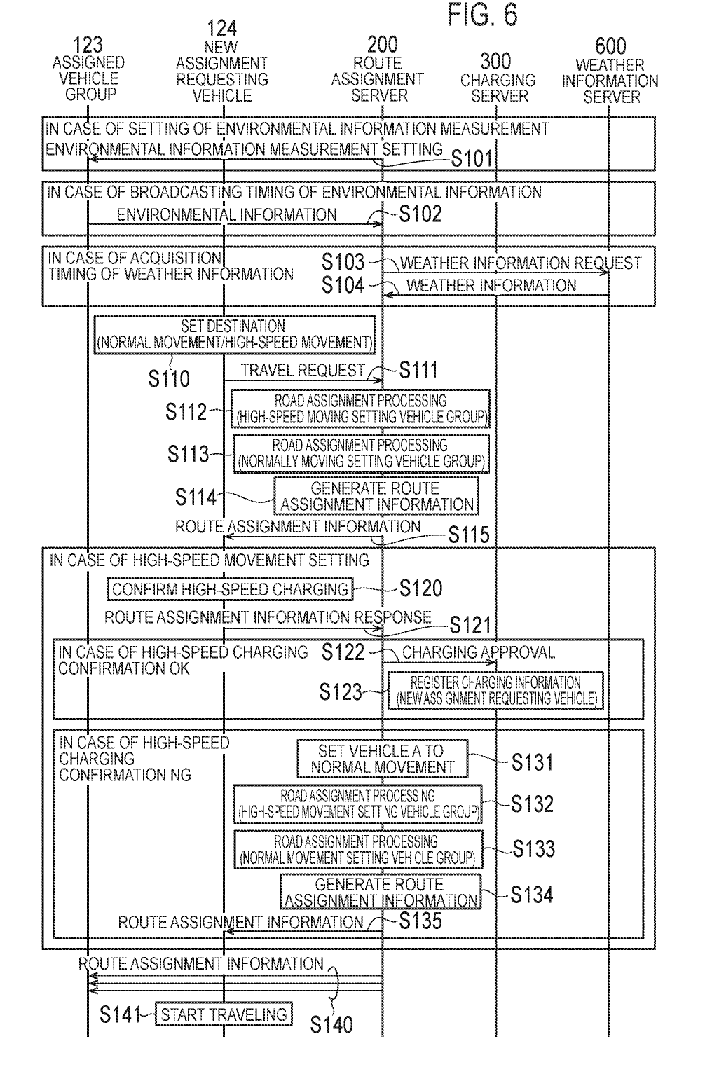

FIG. 6 is a diagram illustrating an example of a flow of the movement setting of the automatically driven vehicle. The vehicles traveling on the road (the vehicle 100 and the manual driving requesting vehicle 160) are classified into a normal movement setting vehicle and a high-speed movement setting vehicle. The normal movement setting vehicle is a vehicle that pays only the charging that is originally required to travel on the road. The high-speed movement setting vehicle is a vehicle that is allowed to travel faster than the normal movement setting vehicle by paying an additional charging in addition to the charging that is originally required for traveling on the road. The assigned vehicle group 123 is a group of vehicles that have already received the route assignment and includes the normal movement setting vehicles and the high-speed movement setting vehicles. A new assignment requesting vehicle 124 is a vehicle to which the route assignment is to be made.

As illustrated in FIG. 6, the route assignment server 200 transmits an environmental information measurement setting to the vehicle determined to require a setting of environmental information measurement among the route-assigned vehicle groups 123 (step S101). The vehicle having received the environmental information measurement setting starts measurement based on the environmental information measurement setting. If a broadcasting timing of the environmental information measured based on the environmental information measurement setting arrives, the vehicle transmits the environmental information with the broadcasting timing to the route assignment server 200 (step S102). The route assignment server 200 holds the received environmental information in the weather information storage unit 206.

If the route assignment server 200 determines that it is the timing when the weather information of the weather information server 600 is to be acquired, the route assignment server 200 transmits a weather information request to the weather information server 600 (step S103). The route assignment server 200 receives the weather information as a response to the weather information request (step S104), and holds the received weather information in the weather information storage unit 206.

In the new assignment requesting vehicle 124, the passenger operates the input unit 105 to set a destination and set “high-speed movement setting” or “normal movement setting” (step S110). The new assignment requesting vehicle 124 notifies the route assignment server 200 of the set request as the travel request (step S111). The travel request includes the vehicle information held in the vehicle information storage unit 113. The vehicle information includes information on components constituting the vehicle, such as a model number of the vehicle, a replacement history of the components, an abrasion situation, a model number of the software of the automatic driving processing, a version, and the like. The travel request includes measurement information. The measurement information is a weight, an occupied area for each height, and the like.

The route assignment server 200 performs road assignment processing for the high-speed movement setting vehicle group based on the travel request, and the environmental information and the weather information held in the weather information storage unit 206 (step S112). Similarly, the route assignment server 200 performs the road assignment processing of the normal movement setting vehicle group (step S113). The route assignment server 200 generates route assignment information of each vehicle (step S114). The route assignment server 200 notifies the route assignment information to the new assignment requesting vehicle 124 (step S115).

If the new assignment requesting vehicle 124 sets “high-speed movement setting” in the travel request, the new assignment requesting vehicle 124 outputs the received route assignment information through the output unit 104 to urge the passenger to confirm the high-speed charging. The passenger inputs the high-speed charging confirmation OK/NG through the input unit 105 (step S120). The new assignment requesting vehicle 124 transmits a route assignment information response including the high-speed charging confirmation to the route assignment server (step S121).

If the high-speed charging confirmation of the route assignment information response is OK, the route assignment server 200 notifies a charging approval message to the charging server 300 (step S122). The charging server 300 stores the charging information including the notified message in the charging information storage unit 303 (step S123).

If the high-speed charging confirmation of the route assignment information response is NG, the route assignment server 200 sets the travel request of the new assignment requesting vehicle 124 to “normal movement setting” (step S131). The route assignment server 200 performs the road assignment processing of the high-speed movement setting vehicle group (step S132). The route assignment server 200 performs the road assignment processing of the normal movement setting vehicle group (step S133). The route assignment server 200 generates route assignment information of each vehicle (step S134). The route assignment server 200 notifies the route assignment information to the new assignment requesting vehicle 124 (step S135). The route assignment server 200 notifies the route assignment information to the assigned vehicle group 123 (step S140). The new assignment requesting vehicle 124 starts traveling based on the received route assignment information (step S141).

Thus, the route assignment server 200 performs the road assignment processing based on the vehicle information such as the model number of the vehicle in each vehicle, the replacement history of the components, the abrasion condition, the model number of the software of the automatic driving processing, the version, or the like, and the vehicle body condition measured by the vehicle. Therefore, it is possible to assign roads according to the traveling performance of individual vehicles, thereby avoiding contact accidents and enabling the high effective use of the road space. Furthermore, the route assignment server 200 performs road assignment processing by taking into account weather information and/or environmental information. This makes it possible to assign roads in consideration of deterioration of the accuracy of travel control accompanying deterioration of the traveling environment, thereby increasing the utilization efficiency of the road space without causing a contact accident.

(Updating Flow of Vehicle Information)

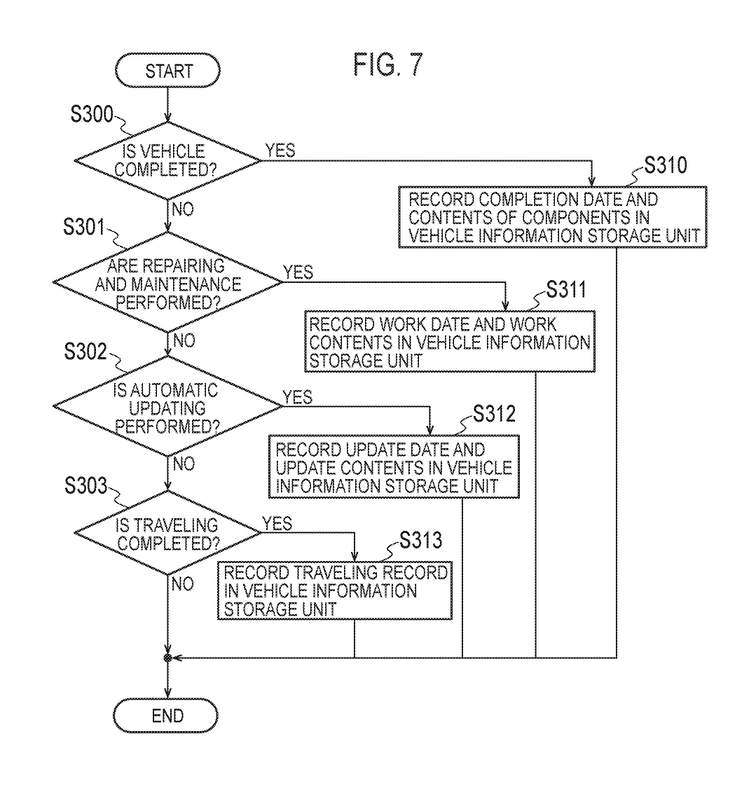

FIG. 7 illustrates an example of a flowchart of updating the vehicle information storage unit.

As illustrated in FIG. 7, if the vehicle is completed (step S300: Yes), the vehicle (vehicle 100 and the manual driving requesting vehicle 160) records a completion date, a type of the vehicle, and components (hardware, software) of the vehicle in the vehicle information storage unit 113 (step S310). If repairing and maintenance are performed (step S301: Yes), the vehicle records work contents such as work date of repairing and maintenance or replaced or added components (hardware, software) in the vehicle information storage unit 113 (step S311). If automatic updating of software or the like is performed (step S302: Yes), the vehicle records the update contents such as an update date, a version of the software that has updated, and the like in the vehicle information storage unit 113 (step S312). Upon completion of the traveling (step S303: Yes), the vehicle (the processing unit 103) records traveling record such as running time, traveling route, and the like in the vehicle information storage unit (step S313).

(Processing Flow Related to Environmental Information and Weather Information)

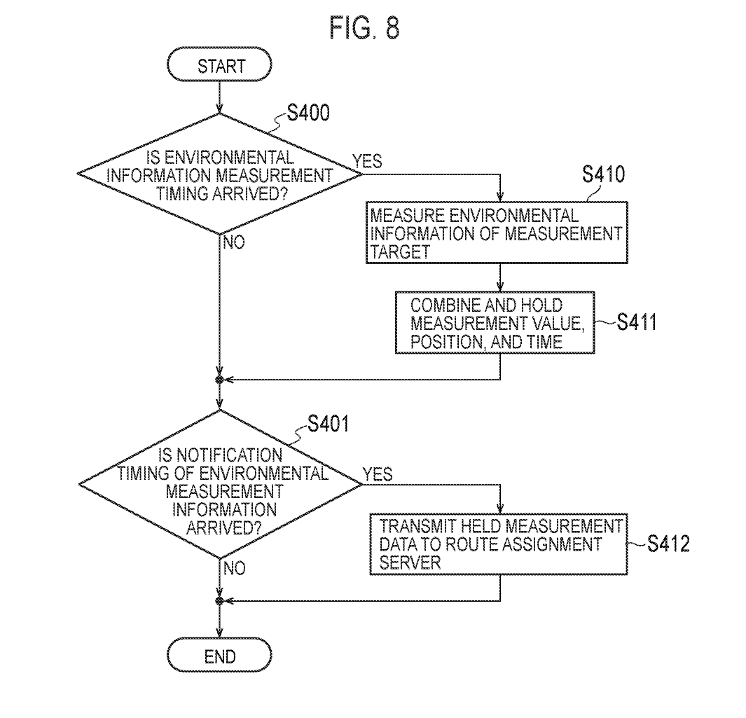

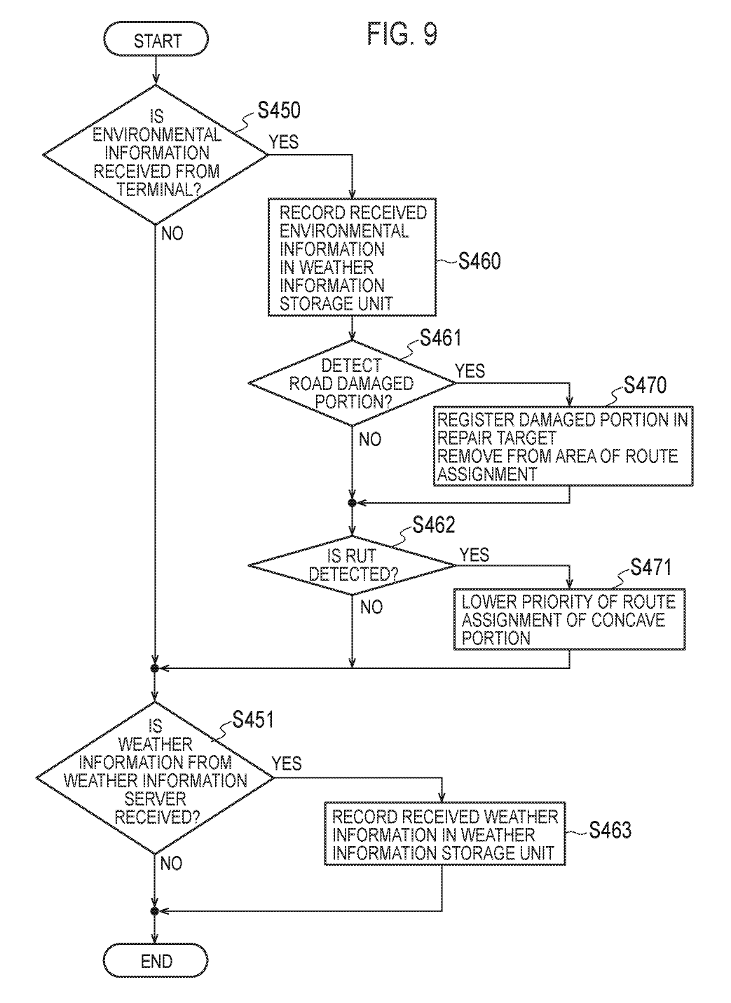

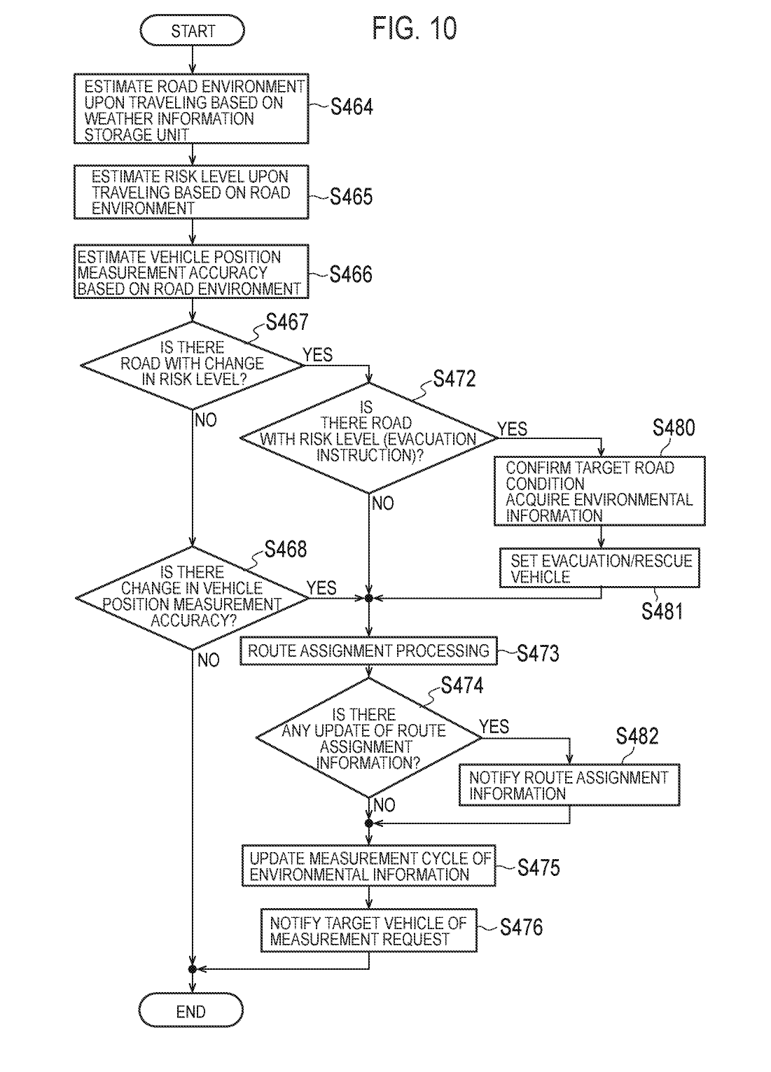

FIG. 8 illustrates an example of a processing flowchart of the vehicle at the time of measuring environmental information. FIG. 9 illustrates an example of a processing flowchart of the route assignment server at the time of receiving environmental information and weather information. FIG. 10 illustrates an example of a processing flowchart of the route assignment server at the time of updating the weather information storage unit.

As illustrated in FIG. 8, if a measurement timing arrives based on an environmental information measurement setting received from the route assignment server 200 (step S400: Yes), the vehicle (the vehicle 100 and the manual driving requesting vehicle 160) measures environmental information of a measurement target (step S410). The vehicle combines and stores the measurement value, the position at the time of measurement, and the time at the time of measurement in the environmental information storage unit 114 (step S411). The environmental information to be measured includes, for example, a wind direction, a wind pressure, an image of a road surface condition, an image of a surrounding situation, a temperature, a pressure, a humidity, a rainfall, a snowfall amount, and the like. If a notification timing based on the environmental information measurement setting arrives (step S401: Yes), the vehicle notifies the route assignment server 200 of the environmental information stored in the environmental information storage unit 114 (step S412). If the vehicle transmits the environmental information to the route assignment server 200, or if the notification of the environmental information to the route assignment server 200 succeeds, the vehicle deletes the corresponding environmental information from the environmental information storage unit 114.

As illustrated in FIG. 9, if the route assignment server 200 receives the environmental information from the vehicle (the vehicle 100 and the manual driving requesting vehicle 160) (step S450: Yes), the route assignment server 200 stores the received environmental information in the weather information storage unit 206 (step S460). If the route assignment server 200 detects a road damaged portion from the received environmental information (step S461: Yes), the route assignment server 200 registers the damaged portion as a repair target and removes the damaged portion from the road area of the route assignment (step S470). In addition, if a rut is detected from the received environmental information (step S462), the route assignment server 200 lowers the priority of route assignment of the road area having the concave portion (step S471). The route assignment server 200 preferentially assigns convexities at the time of route assignment so as to reduce the difference in unevenness of the road so that the road surface is always flat. As a result, the influence on the traveling control due to the unevenness is prevented from occurring. If the weather information from the weather information server 600 is received (step S451: Yes), the route assignment server 200 stores the received weather information in the weather information storage unit 206 (step S463).

As illustrated in FIG. 10, if the weather information storage unit 206 is updated in response to reception of the environmental information or reception of the weather information, the route assignment server 200 estimates road environments after the present time based on the weather information and the environmental information stored in the weather information storage unit 206 (step S464). The route assignment server 200 estimates the risk level of the road based on the estimated road environment (step S465). The route assignment server 200 estimates the vehicle position measurement accuracy based on the estimated road environment (step S466). If there is a road with a change in the risk level (step S467: Yes), and if there is a road with the risk level (evacuation direction) (step S472: Yes), the route assignment server 200 confirms the target road by the sensor or a surveillance camera arranged in the roadside strip, and/or the flying of the unmanned surveillance aircraft, and acquires the environmental information from the vehicle around the target road (step 480). In addition, the route assignment server 200 sets evacuation/rescue vehicles, with respect to vehicles around the target road, aiming to evacuate a person who needs to evacuate and/or a person who needs rescue (step S481). When the vehicle cannot receive a synchronization signal from the base station, the route assignment server 200 selects a vehicle that broadcasts an auxiliary synchronization signal to be used instead of the synchronization signal from the base station, and performs broadcasting. In addition, the route assignment server 200 selects a vehicle as a position reference to be used by other vehicles so as to determine its own vehicle position, and performs broadcasting. The route assignment server 200 performs route assignment processing (step S473). As a result of the route assignment processing, if there is a vehicle with updated route assignment information (step S474: Yes), the route assignment server 200 notifies the route assignment information (step S482). The route assignment server 200 updates the measurement cycle of the environmental information according to the situation (step S475) and notifies the target vehicle of the environmental information measurement setting (step S476). In addition, if there is a change in vehicle position measurement accuracy (step S468: Yes), or if there is no road with a risk level (evacuation direction) (step S472: No), the route assignment server 200 performs route assignment processing (step S473). As a result of the route assignment processing, if there is a vehicle with updated route assignment information (step S474: Yes), the route assignment server 200 notifies the route assignment information (step S482). The route assignment server 200 updates the measurement cycle of the environmental information according to the situation (step 5475) and notifies the target vehicle of the environmental information measurement setting (step S476).

(Occupied Area for Each Height)

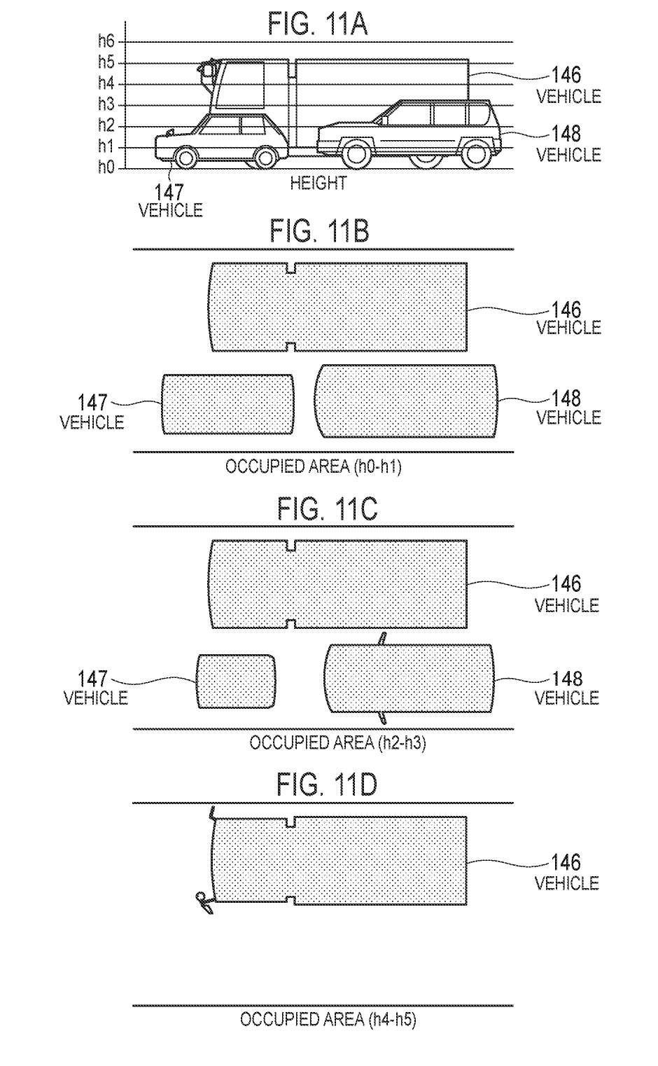

FIGS. 11A to 11D are diagrams illustrating road area occupied for each height (occupied area).

As illustrated in FIGS. 11A to 11D, FIG. A is a view (side view) of a vehicle when seen from the side. FIG. 11B, FIG. 11C and FIG. 11D are views (top views) of a planar surface (cross-sectional surface) of a vehicle when viewed from the above. h0, h1, h2 . . . in FIG. 11A indicate the height from the road surface. FIG. 11B, FIG. 11C and FIG. 11D illustrate part of the occupied area for each height. FIG. 11B illustrates the occupied area of each vehicle at height h0 to h1. FIG. 11C illustrates the occupied area of each vehicle at the height h2 to h3. FIG. 11D illustrates the occupied area of each vehicle at the height h4 to h5. A vehicle 147 and a vehicle 148 have a vehicle height lower than h4. Therefore, although the vehicle 147 and the vehicle 148 have occupied areas in FIG. 11B and FIG. 11C, there is no occupied area in FIG. 11D (h4 to h5). The vehicle 146 has a height of about h5. Therefore, the vehicle 146 has an occupied area in FIG. 11B, FIG. 11C, and FIG. 11D. The occupied area of the vehicle 148 has a substantially rectangular shape in FIG. 11B, but the occupied area in FIG. 11C has a shape in which a side mirror portion protrudes from the rectangular shape. The occupied area of the vehicle 146 has a substantially rectangular shape in FIG. 11B and FIG. 11C, but the occupied area in FIG. 11D has a shape in which the portion of the side mirror protrudes from the rectangular shape. In each of the vehicle 146 and the vehicle 148, it means that attention is paid to the protrusion of the side mirror portion at each height.

(Setting Flow of Minute Period)

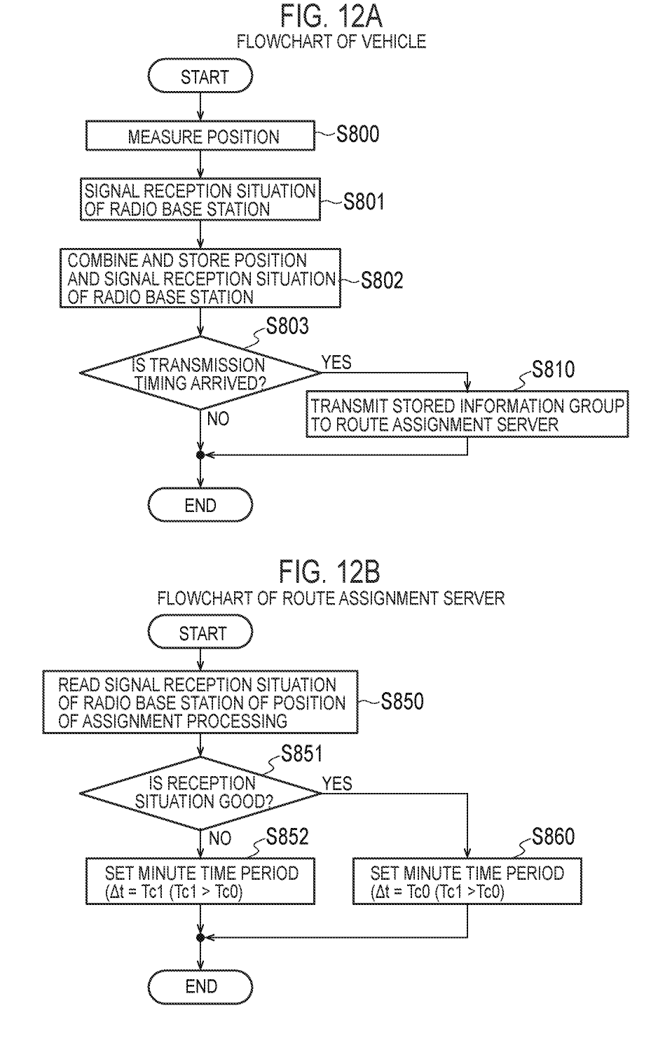

FIGS. 12A to 12B are diagrams illustrating setting flows of a minute period.

As illustrated in FIG. 12A, the vehicle (the vehicle 100 and the manual driving requesting vehicle 160) measures a position by GNSS (step S800), acquires a reception situation of a broadcast signal of the base station 400 (step S801), and combines and stores the position and the reception situation of the broadcast signal of the base station 400 (step S802). If a transmission timing arrives (step 5803: YES), the vehicle transmits, to the route assignment server 200, information group obtained by combining the stored position and the stored reception situation of the broadcast signal of the base station 400 (step S810). The route assignment server 200 receives the information group transmitted by the vehicle and stores the received information group in the road condition storage unit 204.

As illustrated in FIG. 12B, when the route assignment server 200 performs the route assignment processing of the vehicle, the route assignment server 200 reads, from the road condition storage unit 204, the reception situation of the broadcast signal of the base station 400 corresponding to the position to be assigned (step S850). If the reception situation is good, for example, if the reception strength is equal to or higher than a predetermined value (step S851: YES), the route assignment server 200 sets a minute value as the minute period Δt (Δt=T_{c0} (T_{c0}<T_{c1}) (for example, T_{c0} is 1 ms)) (step S860). If the reception situation is not good (step S851: NO), the route assignment server 200 sets a large value as the minute period Δt (Δt=T_{c1} (T_{c0}<T_{c1}) (for example, T_{c1} is 1 sec)) (step S852). Each vehicle occupies the road area designated by each route assignment information at each time timing based on the same synchronization timing. If each vehicle can be synchronized with high accuracy, the route assignment server 200 shortens the minute period and performs control with high accuracy. On the other hand, if the synchronization accuracy of each vehicle is not very high, the route assignment server 200 performs control in a minute period of accuracy according to the accuracy accordingly. This provides safe driving.

(Synchronization Signal)

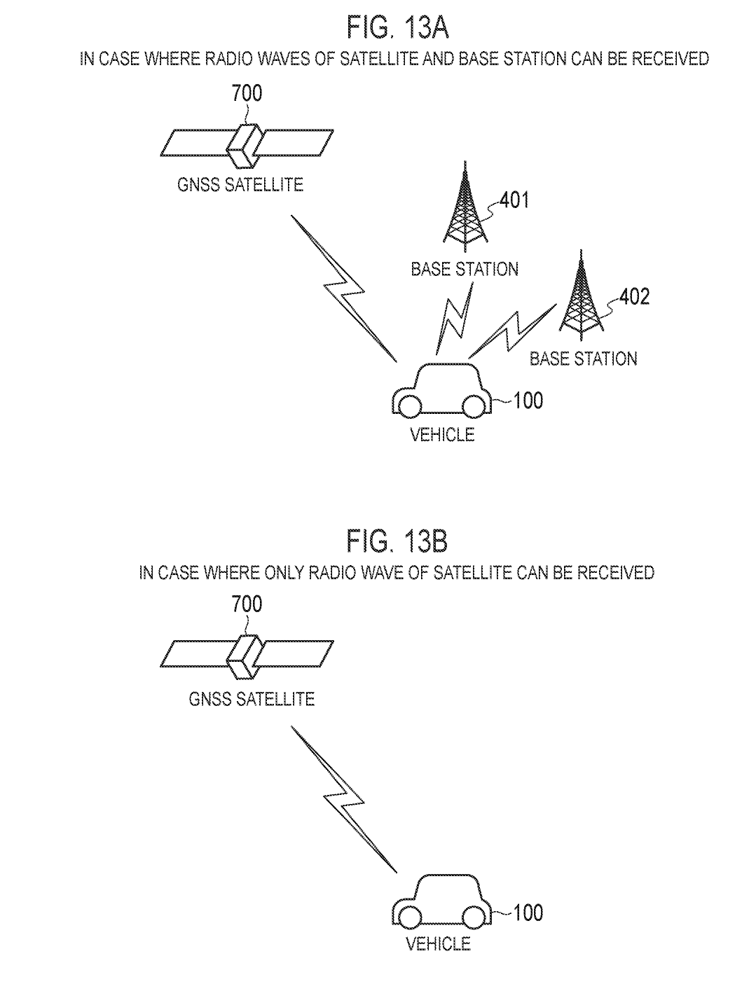

FIGS. 13A to 13B are diagrams illustrating a synchronization signal.

As illustrated in FIG. 13A, the vehicle (the vehicle 100 and the manual driving requesting vehicle 160) receives radio waves from the GNSS satellite 700, radio waves from the base station 401, and radio waves from the base station 402. The vehicle grasps the position of the vehicle by receiving the radio waves from the GNSS satellite 700. The vehicle receives broadcast signals of the base station 401 and/or the base station 402. The vehicle notifies the route assignment server 200 of the position. The vehicle notifies the route assignment server 200 of reception situation of each of the GNSS satellite 700, the base station 401, and the base station 402. The route assignment server 200 selects, from among the GNSS satellite 700, the base station 401, and the base station 402 from which the vehicle can receive a signal at the position, a signal source having a good reception situation and the highest synchronization accuracy so as to use a signal capable of obtaining the highest synchronization accuracy, as a reference signal. The route assignment server 200 sets the synchronization based on the selected signal source. The route assignment server 200 sets a minute period Δt. For example, at a certain position, if the reception situation of each of the GNSS satellite 700, the base station 401, and the base station 402 is good and the synchronization accuracy based on the communication scheme in the base station 402 is higher than the synchronization accuracy based on the communication scheme in the GNSS satellite 700 and the base station 401, the route assignment server 200 selects the synchronization accuracy based on the communication scheme in the base station 402 and sets a minute period Δt based on the synchronization accuracy.

As illustrated in FIG. 13B, the vehicle (the vehicle 100 and the manual driving requesting vehicle 160) receives only radio waves from the GNSS satellite 700. The vehicle grasps the position of the vehicle by receiving radio waves from the GNSS satellite 700. When the vehicle can be connected to communicate with the route assignment server 200, the vehicle notifies the route assignment server 200 of the position and the reception situation of the GNSS satellite. If the reception situation of the GNSS satellite is good in the position, the route assignment server 200 sets the synchronization accuracy based on the radio wave reception of the GNSS satellite and the minute period Δt.

If the synchronization accuracy based on the notification information from the vehicle 100 repeatedly gets better or worse in a shorter period, the route assignment server 200 performs a setting so that the repeated changes do not occur. For example, the route assignment server 200 sets a repeating period so as to match a period with poor accuracy in that period. In addition, the route assignment server 200 broadcast a correction value for matching one synchronization timing based on each position and the signal source, to the vehicle 100. Each vehicle individually travels in an occupied area for each minute time period assigned by the route assignment server 200. The route assignment server 200 sets the occupied area based on the synchronization accuracy and the minute period corresponding to the position of each vehicle, and each vehicle 100 generates the timing to be synchronized, based on the instructed signal source and correction value, synchronizes with this, and travels on the instructed occupied area. This makes it possible for each vehicle to travel without contacting nearby vehicles. Although it is described as the GNSS satellite, it may be a ground station.

(Flow of Travel Request)

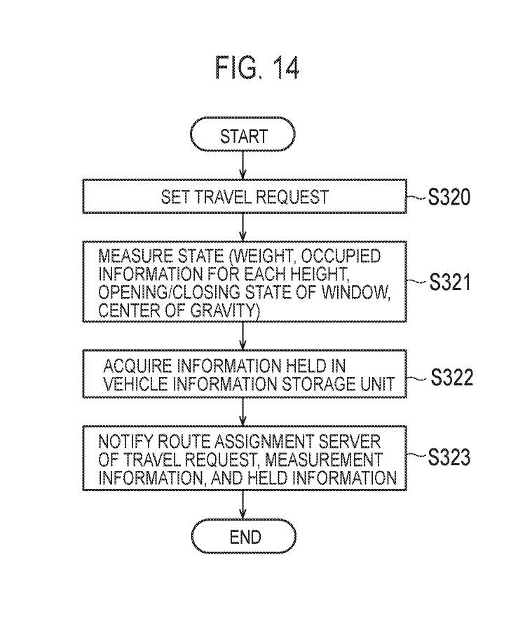

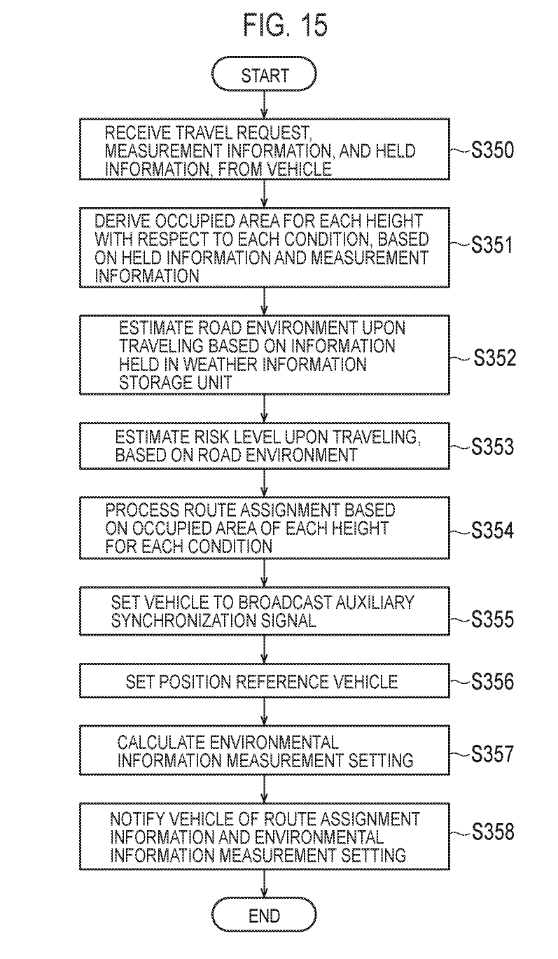

FIG. 14 is an example of a flowchart of the vehicle (the vehicle 100 and the manual driving requesting vehicle 160) upon the travel request of automatically driven vehicle. FIG. 15 illustrates an example of a flowchart of the route assignment server upon the travel request of the automatically driven vehicle.

As illustrated in FIG. 14, in the vehicle, a passenger sets a travel request such as where he/she wants to go to and how to request high-speed movement (step S320). The vehicle measures the state of the vehicle such as the occupied area for each weight and height of the vehicle, the opening/closing state of the window, the center of gravity of the vehicle, and balance (step S321). The vehicle reads vehicle information from the vehicle information storage unit 113 (step S322). The vehicle notifies the route assignment server 200 of the travel request, the measurement information of the state of the vehicle, and the vehicle information held in the vehicle information storage unit 113 (step S323).

As illustrated in FIG. 15, the route assignment server 200 receives the travel request, the measurement information of the state of the vehicle, and the vehicle information held in the vehicle information storage unit 113 (step S350) from the vehicle (the vehicle 100 and the manual driving requesting vehicle 160). The route assignment server 200 calculates the occupied area for each height of the vehicle with respect each road condition based on the vehicle information and the measurement information (step S351). The route assignment server 200 estimates road environments after the present time based on the weather information and the environmental information held in the weather information storage unit 206 (step S352). The route assignment server 200 estimates the risk level of the road based on the estimated road environment (step S353). The route assignment server 200 performs route assignment processing based on the occupied area for each height of each vehicle, the estimated road environment, and the risk level for each of the various calculated road conditions (step S354). When necessary, the route assignment server 200 selects, from among the traveling vehicles, a vehicle as a vehicle broadcasting an auxiliary synchronization signal; and the route assignment server 200 broadcasts the selected vehicle (step S355). In addition, when necessary, the route assignment server 200 selects a vehicle as the position reference of the other vehicle from among the traveling vehicles, and broadcast the selected vehicle (step S356). The route assignment server 200 sets environmental information measurement (step S357), and notifies the vehicle of the route assignment information and the environmental information measurement setting (step S358).

(Setting Flow of Manual Driving)

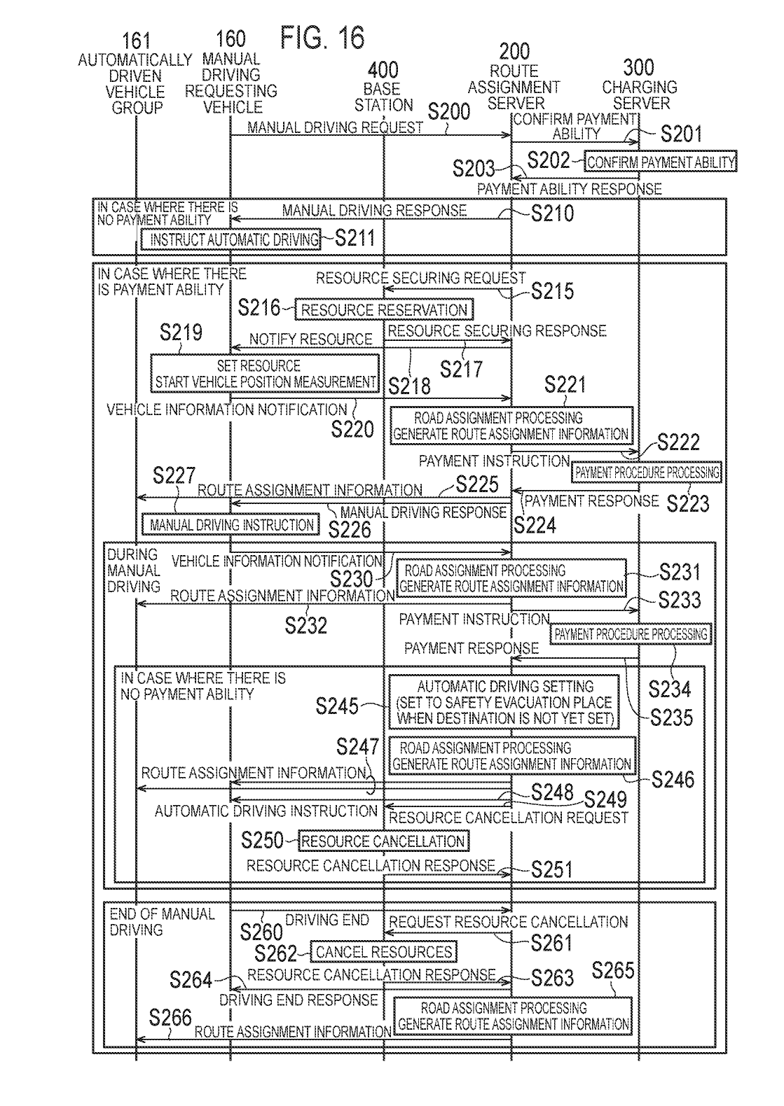

FIG. 16 is a diagram illustrating an example of a flow of manual driving setting.

As illustrated in FIG. 16, the manual driving requesting vehicle 160 transmits a manual driving request to the route assignment server 200 (step S200). The manual driving request includes contents of the manual driving, charging destination, and the like. The route assignment server 200 having received the manual driving request confirms the payment ability to the charging server 300 (step S201). The charging server 300 confirms the payment ability of the designated charging destination (step S202). As a result of the confirmation, the charging server 300 transmits a payment ability response to the route assignment server 200 (step S203).

As a result of the payment ability response, if there is no payment ability, the route assignment server 200 transmits a manual driving response to the manual driving requesting vehicle 160 (step S210). The manual driving response in step S210 has an unauthorized or automatic driving instruction of the manual driving request. Based on the reception of the manual driving response, the output unit 104 outputs an automatic driving instruction to the passenger (step S211).

As a result of the payment ability response, if there is the payment ability, the route assignment server 200 requests the base station 400 or the base station control server to secure radio communication resources (step S215). The base station 400 or the base station control server reserves radio resources (step S216). The base station 400 or the base station control server transmits a resource securing response to the route assignment server 200 (step S217). The route assignment server 200 confirms resource securing and notifies the resource notification to the manual driving requesting vehicle 160 (step S218). Based on the received resource notification, the manual driving requesting vehicle 160 sets resources and starts vehicle position measurement (step S219). The manual driving requesting vehicle 160 notifies the route assignment server 200 of the vehicle information notification by using the set resource (step S220). The vehicle information notification includes measurement values in the vehicle position measurement and driving information such as a speed, an acceleration, an actual steering angle, and a vehicle body direction in the driving control. Based on the vehicle information notification, the route assignment server 200 performs road assignment processing of the automatically driven vehicle group 161 and generates route assignment information (step S221).

Based on the result of the road assignment processing, the route assignment server 200 calculates a payment request amount to the manual driving requesting vehicle 160 and transmits a payment instruction to the charging server 300 (step S222). According to the payment instruction, the charging server 300 performs payment procedure processing to the charging destination associated with the manual driving requesting vehicle 160 (step S223). The charging server 300 notifies a payment response to the route assignment server 200 (step S224).

The route assignment server 200 transmits route assignment information to the automatically driven vehicle group 161 (step S225). The route assignment server 200 transmits a manual driving response to the manual driving requesting vehicle 160 (step S226). The manual driving response includes the permission of the manual driving. Based on the reception of the manual driving response, the output unit 104 outputs a manual driving instruction to the passenger (step S227).

During the manual driving, the manual driving requesting vehicle 160 always transmits the vehicle information notification to the route assignment server 200 (step S230). Based on the vehicle information notification, the route assignment server 200 performs road assignment processing of the automatically driven vehicle group 161 and generates route assignment information (step S231). The route assignment server 200 notifies the automatically driven vehicle group 161 of the route assignment information (step S232).

Based on the result of the road assignment processing, the route assignment server 200 calculates a payment request amount to the manual driving requesting vehicle 160 and transmits a payment instruction to the charging server 300 (step S233). According to the payment instruction, the charging server 300 performs payment procedure processing to the charging destination associated with the manual driving requesting vehicle 160 (step S234). The charging server 300 notifies the route assignment server 200 of the payment response indicating the situation of the payment (step S235). When the route assignment server 200 receives the payment response, the route assignment server 200 confirms the payment situation through the payment response.

As a result of the confirmation, if there is no payment ability, the route assignment server 200 sets the manual driving requesting vehicle 160 to the automatic driving (step S245). At this time, if a destination is not set, the route assignment server 200 sets a safety evacuation place nearby as a destination. The route assignment server 200 performs the road assignment processing of the automatically driven vehicle group 161 including the manual driving requesting vehicle 160 and generates the route assignment information (step S246), and transmits the route assignment information to the automatically driven vehicle group 161 and the manual driving requesting vehicle 160 (step S247). In addition, the route assignment server 200 transmits the automatic driving instruction to the manual driving requesting vehicle 160 (step S248). The route assignment server 200 requests the base station 400 or the base station control server to cancel the securing of resources for radio communication (step S249). The base station 400 or the base station control server cancels the securing of radio resources (step S250). The base station 400 or the base station control server transmits a resource cancellation response to the route assignment server 200 (step S251).

When the manual driving requesting vehicle 160 stops and the passenger inputs the end of the manual driving through the input unit 105 or the passenger operates the stop of the engine, the manual driving requesting vehicle 160 transmits the driving end to the route assignment server 200 (step S260). The route assignment server 200 requests the base station 400 or the base station control server to cancel the securing of resources for radio communication (step S261). The base station 400 or the base station control server cancels the securing of radio resources (step S262). The base station 400 or the base station control server transmits a resource cancellation response to the route assignment server 200 (step S263). The route assignment server 200 transmits the driving end response to the manual driving requesting vehicle 160 (step S264). The route assignment server 200 performs road assignment processing of the automatically driven vehicle group 161 and generates route assignment information (step S265). The route assignment server 200 transmits the route assignment information to the automatically driven vehicle group 161 (step S266).

If the manual driving requesting vehicle 160 is set to end the manual driving in a state in which the manual driving requesting vehicle 160 does not stop at a place where the passenger safely get off, the route assignment server 200 sets the manual driving requesting vehicle 160 to the automatic driving as in the case of no payment ability during manual driving (step S245), performs road assignment processing and generates route assignment information (step S246), transmits the route assignment information to the manual driving requesting vehicle 160 (step S247), transmits the automatic driving instruction (step S248), and cancels the secured radio resources (steps S249 to S251).

(Manual Driving Determination Flow by Driving Qualification)

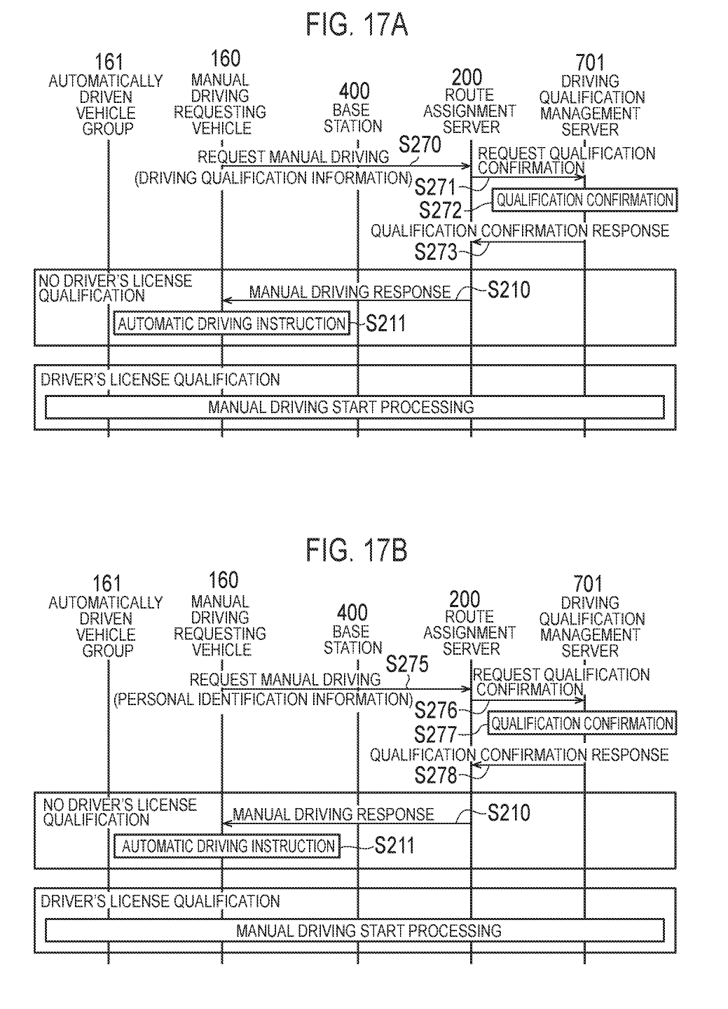

FIGS. 17A to 17B are diagrams illustrating an examples of a manual driving determination flows by driving qualification.

As illustrated in FIG. 17A, the route assignment server 200 acquires the driving qualification information of the driver of the manual driving requesting vehicle 160 at the time of requesting the manual driving of the manual driving requesting vehicle 160 (step S270). The route assignment server 200 confirms the validity of the driving qualification information to the driving qualification management server 701 (steps S271 to 273). If the validity of the driving qualification information cannot be confirmed, the route assignment server 200 instructs the manual driving requesting vehicle 160 to perform the automatic driving (step S210). The qualification confirmation request includes information such as the driving qualification information and the model of the manual driving requesting vehicle 160. In addition, if there is no problem even if it is determined that it has the driving qualification of the manual driving requesting vehicle 160 with the contents indicated by the driving qualification information, the route assignment server 200 may determine that the manual driving may be performed without making an inquiry to the driving qualification management server 701.

As illustrated in FIG. 17B, upon the manual driving request of the manual driving requesting vehicle 160, the route assignment server 200 acquires the personal identification information of the driver of the manual driving requesting vehicle 160 (step S275), and confirms to the driving qualification management server 701 whether the driver has a driving qualification, based on the driver's personal identification information (steps S276 to S278). If the route assignment server 200 cannot confirm that the driver has the driving qualification, the route assignment server 200 instructs the automatic driving to the manual driving requesting vehicle 160 (step S210). The qualification confirmation request includes information such as the driver's personal identification information and the model of the manual driving requesting vehicle 160. In addition, the driving qualification management server 701 may confirm that it is driving qualification information corresponding to the driver's personal identification information, based on both the personal identification information of the driver and the driving qualification information, and may determine whether the driver of the manual driving requesting vehicle has the driving qualification.

(Manual Driving Determination Flow by Insurance Information)

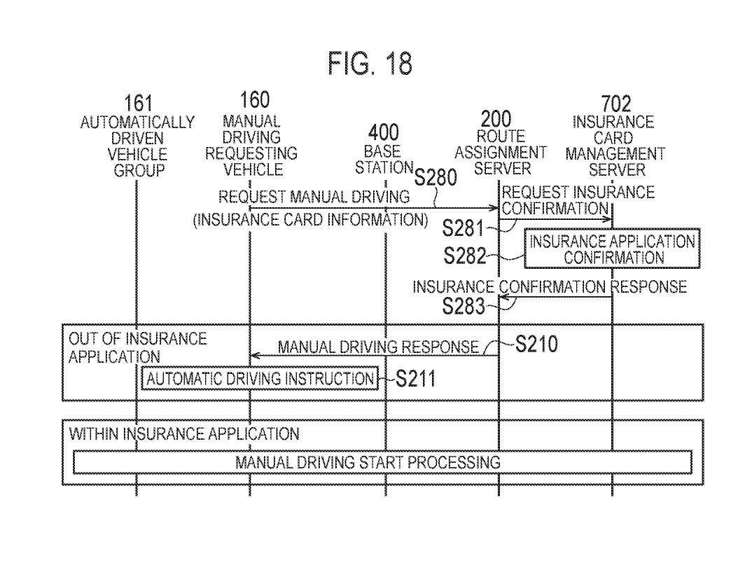

FIG. 18 is a diagram illustrating an example of a manual driving determination flow by insurance card information.

As illustrated in FIG. 18, upon the manual driving request of the manual driving requesting vehicle 160, the route assignment server 200 acquires insurance card information such as (personal/property) insurance for accidents or the like associated with the manual driving requesting vehicle 160, or (personal/property) insurance for accidents or the like associated with the driver of the manual driving requesting vehicle 160 (step S280). The route assignment server 200 confirms the validity of the insurance card information to the insurance card management server 702 (steps S281 to S283). If the validity of the insurance card information cannot be confirmed, the route assignment server 200 instructs the manual driving requesting vehicle 160 to perform the automatic driving (step S210). In addition, if the travel setting in the manual driving is not determined to be within the insurance applicable range of the insurance card information, the route assignment server 200 instructs the automatic driving to the manual driving requesting vehicle 160. In addition, the insurance card management server 702 may hold the driver's driving history and may set a permissible driving setting based on the driving history. In addition, in the description contents of the insurance card information, in a case where there is no problem even when it is determined that it is within the insurance application range of the insurance card information with respect to the travel setting in the manual driving, the route assignment server 200 may determine that the manual driving may be performed without making an inquiry to the insurance card management server 702.

(Manual Driving Determination Flow by Physical Information)

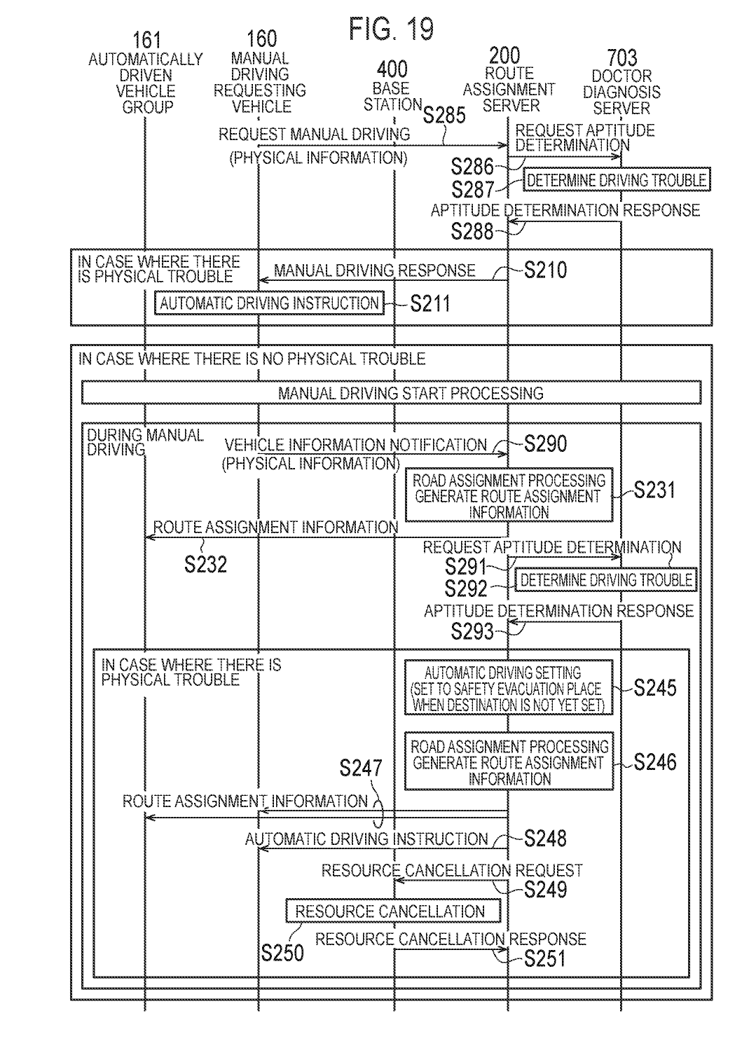

FIG. 19 is a diagram illustrating an example of a manual driving determination flow by physical information.

As illustrated in FIG. 19, the route assignment server 200 acquires the physical information of the driver of the manual driving requesting vehicle 160 at the time of requesting the manual driving of the manual driving requesting vehicle 160 (step S285). The route assignment server 200 confirms, based on the physical information, whether the body of the driver is not obstructive to driving, to a doctor diagnosis server 703 (steps S286 to S288). If the route assignment server 200 cannot confirm that there is no trouble in driving, the route assignment server 200 transmits a manual driving response and instructs the automatic driving to the manual driving requesting vehicle 160 (steps S210 and S211).

While the manual driving requesting vehicle 160 is in the manual driving, the route assignment server 200 receives the vehicle information notification transmitted from the manual driving requesting vehicle 160 and acquires the physical information of the driver of the manual driving requesting vehicle 160 (step S290). The route assignment server 200 confirms, based on the physical information, whether the body of the driver is not obstructive to driving, to the doctor diagnosis server 703 (steps S291 to S293). If the route assignment server 200 cannot confirm that there is no trouble in driving, the route assignment server 200 shifts to automatic driving (steps S245 to 251).

If the physical information cannot be acquired for a certain period or more during the manual driving of the manual driving requesting vehicle 160, the route assignment server 200 shifts the manual driving requesting vehicle 160 to the automatic driving. If the information itself about the physical condition cannot be acquired, the route assignment server 200 instructs the manual driving requesting vehicle 160 to perform the automatic driving.

More specifically, the driver of the manual driving requesting vehicle 160 wears the body management device, and when the driver contacts the manual driving unit 117 such as a steering wheel, information about the physical condition measured by the body management device is acquired through a human body communication. The manual driving requesting vehicle 160 notifies the route assignment server 200 of the information about the physical condition in response to the manual driving request.

The body management device worn by the driver is, for example, a micromachine flowing in the blood (in a blood vessel). The communication unit (manual driving unit 117) with the micromachine is arranged on the steering wheel. The manual driving unit 117 measures the total number of micromachines flowing in the blood, and notifies the doctor diagnosis server 703 of the measurement result through the route assignment server 200. Based on the measurement result, the doctor diagnosis server 703 estimates the state of the blood vessel, whether the blood vessel is clogged somewhere, and estimates the possibility of the acute coronary syndrome. The micromachine has information about a disease history, and the manual driving unit 117 acquires information about the disease history and notifies the doctor diagnosis server 703 through the route assignment server 200. The micromachine includes an infrared light receiving unit, and the manual driving unit 117 acquires the amount of light received by the light receiving unit and notifies the doctor diagnosis server 703 of the received light amount through the route assignment server 200. Based on the received amount of light, the doctor diagnosis server 703 estimates a blood glucose level based on the received light amount and further estimates a sleeping state. In addition, the doctor diagnosis server 703 estimates a blood alcohol concentration. Based on the disease history, the route assignment server 200 instructs the automatic driving if the driver has a disease prohibited to driving and/or if the doctor's permission cannot be confirmed by the doctor diagnosis server 703. The route assignment server 200 instructs the automatic driving if the doctor diagnosis server 703 determines that there is a high possibility of an acute coronary syndrome such as myocardial infarction or the like, if the doctor diagnosis server 703 determines that there is a high possibility of dozing driving, or if the doctor diagnosis server 703 determines that there is a high possibility of drunk driving. The steering wheel that is the manual driving unit 117 may have a function of irradiating infrared light, or the micromachine may have the function of irradiating infrared light. The micromachine may have a function of collecting measurement values measured by each micromachine and notifying the collected information to the manual driving unit 117.

Here, the function of determining the physical condition from the physical information is provided in the doctor diagnosis server 703 on the network, but part or all of the functions may be a part of functions of the route assignment server 200. The physical information to be transmitted in response to the manual driving request may also include previously measured information.

(Flow of Securing Communication Path)

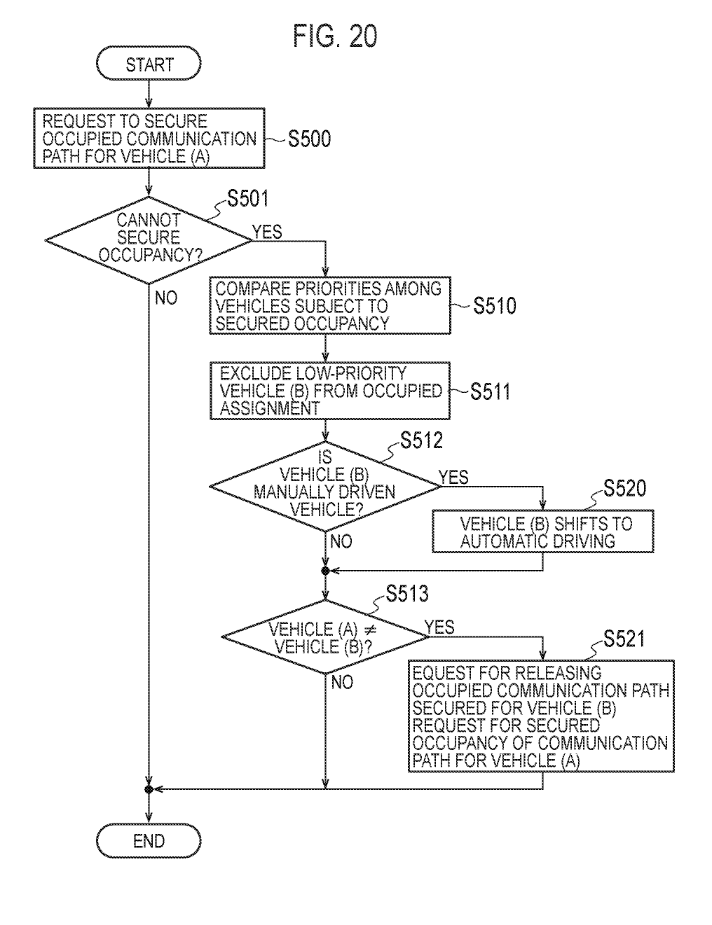

FIG. 20 illustrates an example of a flowchart of the processing of securing the communication path of the manual driving requesting vehicle in the route assignment server 200.

As illustrated in FIG. 20, the route assignment server 200 requests the base station 400 or the base station control server to secure the occupied communication path for the vehicle (A) that desires the manual driving (securing the occupied communication path) (step S500). If the occupancy cannot be secured (step S501: Yes), the route assignment server 200 compares the priorities of vehicles subject to securing the occupied communication path, including the vehicle (A) (step S510). The route assignment server 200 excludes the lowest-priority vehicle (B) from the occupied assignment of the communication path (step S511). If the vehicle (B) is a manually driven vehicle (step S512: Yes), the route assignment server 200 shifts the vehicle (B) to the automatic driving (step S520). If the vehicle (B) is not the vehicle (A) (step S513: Yes), the route assignment server 200 requests, to the base station 400 or the base station control server, a request for releasing the occupied communication path secured for the vehicle (B) and securing of the occupied communication path for the vehicle (A) (step S521). If the occupied communication path can be secured, the manual driving is permitted to the manual driving requesting vehicle.

(Example of Travel Setting)

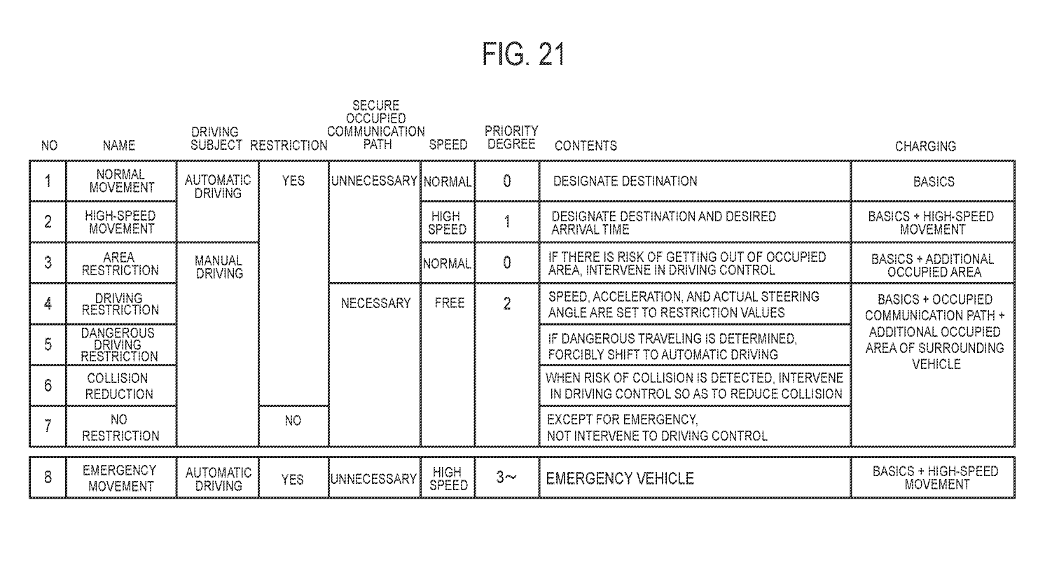

FIG. 21 illustrates an example of travel setting.

As illustrated in FIG. 21, the travel setting includes normal movement, high-speed movement, area restriction, driving restriction, dangerous driving restriction, collision reduction, no restriction, urgent movement, and the like. These travel settings may be set by the vehicle (the vehicle 100 and the manual driving requesting vehicle 160) or may be set by the route assignment server 200. If the vehicle sets, the set travel setting may be notified to the route assignment server 200 by, for example, a manual driving request or a vehicle information notification. If the route assignment server 200 sets, for example, the travel setting may be instructed to the vehicle by a manual driving instruction or an automatic driving instruction.

Normal movement, high-speed movement, and emergency movement are the automatic driving. Area restriction, driving restriction, dangerous driving restriction, collision reduction, and no restriction are the manual driving.

Driving restrictions, dangerous driving restriction, collision reduction, and no restriction require securement of the occupied communication path.

In high-speed movement and emergency movement, the traveling speed is high. In driving restriction, dangerous driving restriction, collision reduction, and no restriction, the traveling speed is free.

The priority of normal movement and area restriction is set to low (=0). High-speed movement is set to the next highest priority (=1). Driving restriction, dangerous driving restriction, collision reduction, and no restriction are set to the next highest priority (=2). Emergency movement is set to the further higher priority (=3˜). By using these priorities, the route assignment server 200 performs road assignment in descending order of priority.

Charging in normal movement is only basic charging (charging originally required for traveling on the road). The charging for high-speed movement and emergency movement is the amount based on basic charging and high-speed movement. The charging for the area restriction is basic charging and charging based on the additional occupied area. The charging for driving restriction, dangerous driving restriction, collision reduction, and no restriction is basic charging, charging based on utilization of occupied communication paths, and charging for additional occupied areas of surrounding vehicles including the vehicle. The basic charging is basically 0 and may be a charging for uniform payment for all vehicles at the time of toll roads. The charging based on the high-speed movement, the charging based on additional occupied area, the charging based on the utilization of occupied communication paths, and the charging for the additional occupied area of surrounding vehicles are additional charging that must be paid in addition to basic charging. The charging based on high-speed movement is charging for high-speed movement rather than normal movement and is derived based on the state of high-speed movement when compared with normal movement. The charging for the additional occupied area is charging for the occupied area expanded from the normal movement and requests payment every minute period. The charging for the occupied communication path is charging for occupancy use of the communication path and requests payment every minute period. The charging for the additional occupied area of the surrounding vehicle is charging for the occupied area added by the vehicle in association with manual driving in all surrounding vehicles including the vehicle and requests payment every minute period.

In the case of the normal movement (normal movement setting vehicle), the route assignment server 200 derives the traveling route (performs road assignment) based on the setting of the destination from the passenger. The vehicle (the vehicle 100 and the manual driving requesting vehicle 160) starts traveling.

In the case of the high-speed movement (high-speed movement setting vehicle), the route assignment server 200 derives the traveling route based on the destination from the passenger and the setting of the desired arrival time and derives the charging for high-speed movement (payment request amount). The vehicle starts traveling if the charging for the high-speed movement is permitted by the passenger.

In the case of the area restriction, the route assignment server 200 derives the traveling route based on the destination from the passenger and the desired setting of the area restriction and derives charging for the additional occupied area, and the vehicle starts traveling. Payment processing is continued every minute period with respect to the charging accompanying the additional occupied area, and if there is no payment ability, the setting automatically shifts to the normal movement.

In the case of the driving restriction, the route assignment server 200 secures the occupied communication path based on the desire of driving restriction from the passenger. The payment processing is continued every minute period with respect to charging for the occupied communication path and charging for the occupied area added in association with the manual driving of the vehicle in all surrounding vehicles including the vehicle. If there is no payment ability, the setting automatically shifts to the normal movement. A value range that can be operated for each position is set, and the speed, the acceleration, and the actual steering angle by the manual driving are kept within the value range.

In the case of the emergency driving restriction, the route assignment server 200 secures the occupied communication path based on the desire of emergency driving restriction from the passenger. The payment processing is continued every minute period with respect to charging for the occupied communication path and charging for the occupied area added in association with the manual driving of the vehicle in all surrounding vehicles including the vehicle. If there is no payment ability, the setting automatically shifts to the normal movement. For example, if the route assignment server 200 or the vehicle determines that the manual driving is dangerous, the route assignment server 200 or the vehicle automatically shifts to the automatic driving.

In the case of the collision reduction, the route assignment server 200 secures the occupied communication path based on the desire of collision reduction from the passenger. The payment processing is continued every minute period with respect to charging for the occupied communication path and charging for the occupied area added in association with the manual driving of the vehicle in all surrounding vehicles including the vehicle. If there is no payment ability, the setting automatically shifts to the normal movement. For example, if the route assignment server 200 or the vehicle determines that there is a possibility of collision or contact by manual driving, the route assignment server 200 or the vehicle intervenes in the control such as the speed, the acceleration, the actual steering angle, or the like, so as to reduce the degree of collision or contact.

In the case of no restriction, the route assignment server 200 secures the occupied communication path based on the desire of no restriction from the passenger. The payment processing is continued every minute period with respect to charging for the occupied communication path and charging for the occupied area added in association with the manual driving of the vehicle in all surrounding vehicles including the vehicle. If there is no payment ability, the setting automatically shifts to the normal movement.

In the case of the emergency movement, the route assignment server 200 calculates the traveling route based on the setting of the destination from the passenger and the desire of the emergency movement, and calculates the charging for high-speed movement, and the vehicle starts traveling. Part or all charging is billed to a user of emergency movement. When the vehicle is traveling in emergency movement, the route assignment server 200 sets all the vehicles existing around the emergency traveling vehicle, which are lower in priority of emergency traveling, to the automatic driving (emergency driving setting).

If an emergency evacuation such as a disaster is required, or if a special situation such as detection of a failure part in the vehicle is determined, the route assignment server 200 forcibly shifts all vehicles to the automatic driving.

(Processing Flow of Manual Driving)

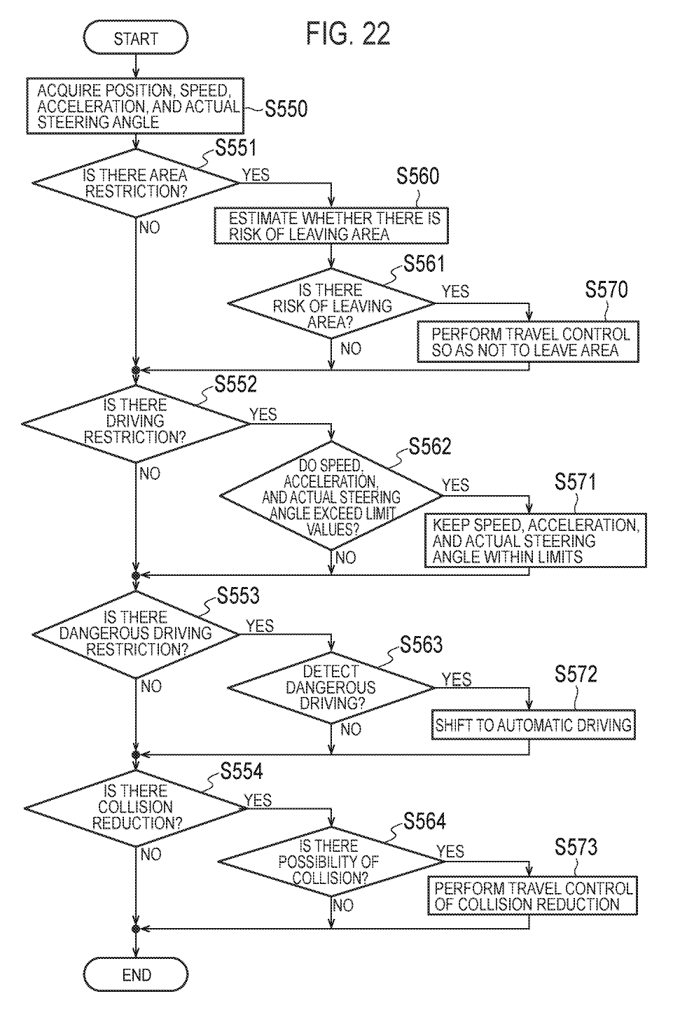

FIG. 22 illustrates an example of a processing flowchart when the manual driving requesting vehicle 160 is manually driven.

As illustrated in FIG. 22, the sensor unit 111 acquires the position, and the driving control unit 112 acquires the speed, the acceleration, the actual steering angle, and the vehicle body direction (step S550).

If the area limitation is set as the travel setting (step S551: Yes), the manual driving requesting vehicle 160 estimates, from the position, the speed, the acceleration, the actual steering angle, and the vehicle body direction, whether there is a possibility of leaving the set area (step S560). If there is a possibility of leaving the set area (step S561: Yes), the manual driving requesting vehicle 160 performs travel control so as not to leave the area (step S570).

In a case where the driving restriction is set as the travel setting (step S552: Yes), if the speed, the acceleration, and the actual steering angle exceed the limit values of the traveling position, the speed, the acceleration, and the actual steering angle in the direction of the vehicle body (step S562: Yes), the manual driving requesting vehicle 160 keeps the speed, the acceleration, and the actual steering angle within the limits (step S571).

In a case where the dangerous driving restriction is set as the travel setting (step S553: Yes), if it is detected that the dangerous driving is being performed (step S563: Yes), the manual driving requesting vehicle 160 shifts to the automatic driving. As the determination as to whether the dangerous driving is being performed, the dangerous driving is determined if the driving having the risk of inducing contact with a nearby vehicle. For example, there are sudden acceleration, repetition of sudden braking, repetition of sudden steering wheel, and meandering driving regardless of road conditions. As the shift of the automatic driving, the automatic driving request is transmitted to the route assignment server 200.

In a case where the collision reduction is set as the travel setting (step S554: Yes), if it is determined that there is a possibility of collision (step S564: Yes), the manual driving requesting vehicle 160 performs travel control of collision reduction (step S573). The determination as to whether there is a possibility of collision is made based on the determination as to whether there is a possibility that the vehicle will collide with the nearby vehicle based on the vehicle position, the speed, the acceleration, the actual steering angle, and the vehicle body direction of the vehicle and the nearby vehicle. If there is a risk of collision, the manual driving requesting vehicle 160 intervenes in the travel control of the vehicle and controls the speed, the acceleration, and the actual steering angle to reduce collision with the nearby vehicle. For example, there are the reduction in the speed by the brake and the change in the traveling course by changing the actual steering angle.

At least one of the steps illustrated in FIG. 22 may be performed by the route assignment server 200.

(Instruction Delay Time)

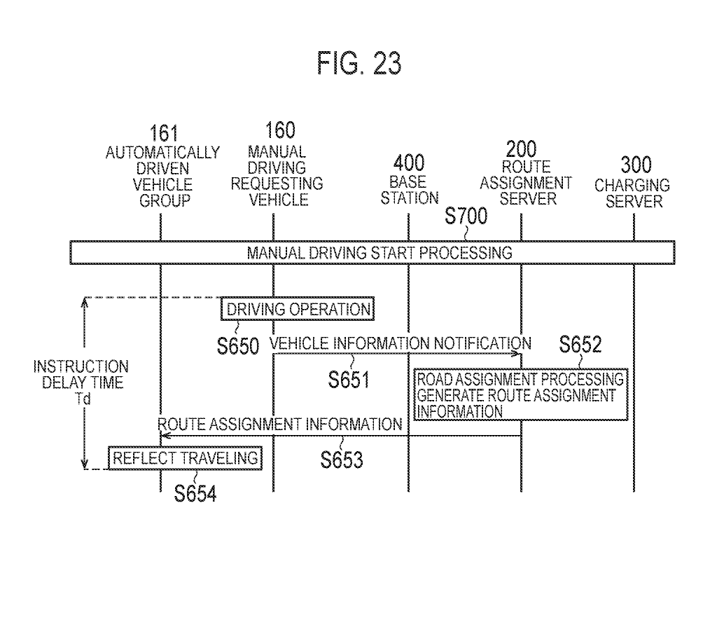

FIG. 23 is a diagram illustrating an instruction delay time. The manual driving requesting vehicle 160 is in a state of manual driving.

As illustrated in FIG. 23, the driving operation by the passenger is performed in the manual driving requesting vehicle 160 (step S650). The vehicle information notification including driving information such as the position, the speed, the acceleration, and the actual steering angle, which are accompanied by the accelerator, the brake, and the rear ring by the driving operation, is transmitted from the manual driving requesting vehicle 160 to the route assignment server 200 through the occupied communication path (step S651). Based on the reception of the vehicle information communication, the route assignment server 200 performs road assignment processing and generates route assignment information (step S652). The route assignment server 200 transmits the route assignment information to the surrounding automatically driven vehicle group 161 (step S653). Upon receiving the route assignment information, the automatically driven vehicle group 161 performs travel control based on the route assignment information (step S654).

The time from the driving operation of the manual driving requesting vehicle 160 until the automatically driven vehicle group 161 receives the route assignment information and reflects the same to the traveling is an instruction delay time which is the time required for the traveling of the automatically driven vehicle group 161 corresponding to the driving operation of the manual driving requesting vehicle 160.

(Safety Distance)

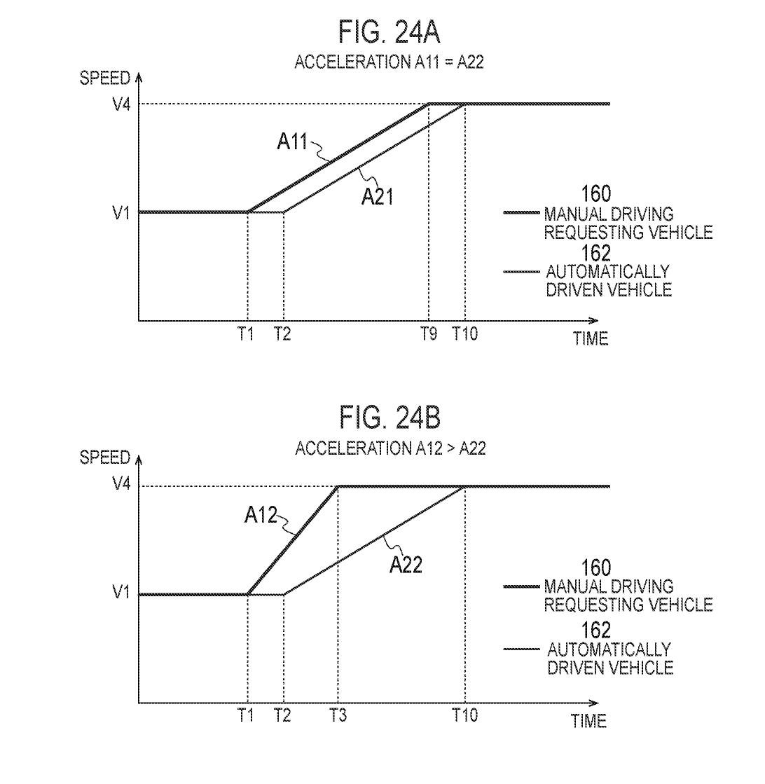

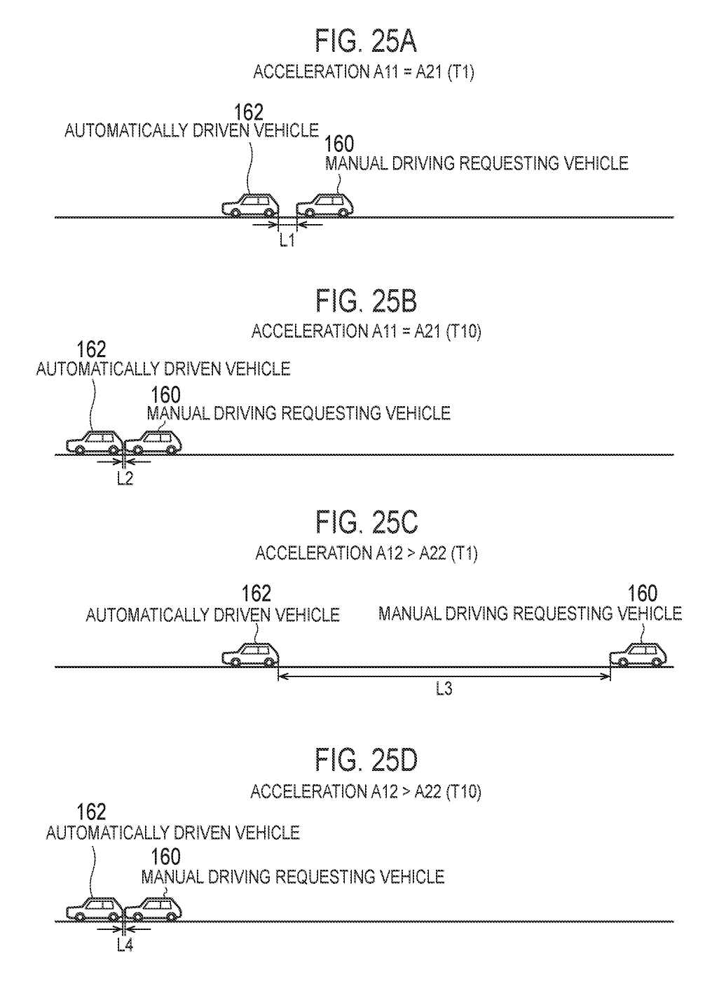

FIGS. 24A to 24B and FIGS. 25A to 25D are diagrams illustrating the distance serving as the reference for the distance between the automatically driven vehicle and the manually driven vehicle. In FIGS. 24A to 24B, a vertical axis represents the speed and a horizontal axis represents the time. A thick line indicates the speed change of the manual driving requesting vehicle 160, a thin line indicates the speed change of the automatically driven vehicle 162, and the speed is increased from a speed V1 to a speed V4. FIG. 24A illustrates a case where the relationship between an acceleration A11 of the manual driving requesting vehicle 160 and an acceleration A21 of the automatically driven vehicle 162 is A11=A21. FIG. 24B illustrates a case where the relationship between an acceleration A12 of the manual driving requesting vehicle 160 and an acceleration A22 of the automatically driven vehicle 162 is A12>A22. The time (=T2−T1) of the period [T1−T2] is the instruction delay time. FIG. 25A illustrates the inter-vehicular distance at time T1 in FIG. 24A. FIG. 25B illustrates the inter-vehicular distance at time T10 in FIG. 24A. FIG. 25C illustrates the inter-vehicular distance at time T1 in FIG. 24B. FIG. 25D illustrates the inter-vehicular distance at time T10 in FIG. 24B.

As illustrated in FIG. 24A, the manual driving requesting vehicle 160 moving at the speed V1 accelerates at the acceleration A11 at the time T1 and stops the acceleration when reaching the speed V4 at the time T9. Based on the acceleration at the time T1, the automatically driven vehicle 162 is accelerated at the acceleration A21 at the time T2 as much as the delay of the instruction delay time. The automatically driven vehicle 162 reaches the speed V4 at time T10 after the time T9. When the inter-vehicular distance between the manual driving requesting vehicle 160 and the automatically driven vehicle 162 at the time T10 is set to a minimum distance L2 that allows safe traveling (FIG. 25B), the inter-vehicular distance between the manual driving requesting vehicle 160 and the automatically driven vehicle 162, which is required at the time T1, is the distance L1 (>L2) (FIG. 25A).

As illustrated in FIG. 24B, the manual driving requesting vehicle 160 moving at the speed V1 accelerates at the acceleration A21 at the time T1 and stops the acceleration when reaching the speed V4 at the time T3. Based on the acceleration at the time T1, the automatically driven vehicle 162 is accelerated at the acceleration A22 at the time T2 as much as the delay of the instruction delay time. The automatically driven vehicle 162 reaches the speed V4 at time T10 after the time T3. When the inter-vehicular distance between the manual driving requesting vehicle 160 and the automatically driven vehicle 162 at the time T10 is set to a minimum distance L4 that allows safe traveling (FIG. 25D), the inter-vehicular distance between the manual driving requesting vehicle 160 and the automatically driven vehicle 162, which is required at the time T1, is the distance L3 (>L1>L2) (FIG. 25C).

In response to the traveling of the manual driving requesting vehicle 160, the reaction of the automatically driven vehicle 162 is delayed by the instruction delay time. Therefore, it is necessary to secure an inter-vehicular distance in anticipation of that. Furthermore, if there is a difference in acceleration between the manually driven vehicle 160 and the automatically driven vehicle 162, it is necessary to further secure an inter-vehicular distance according to the difference in acceleration.

(Driving Restriction)

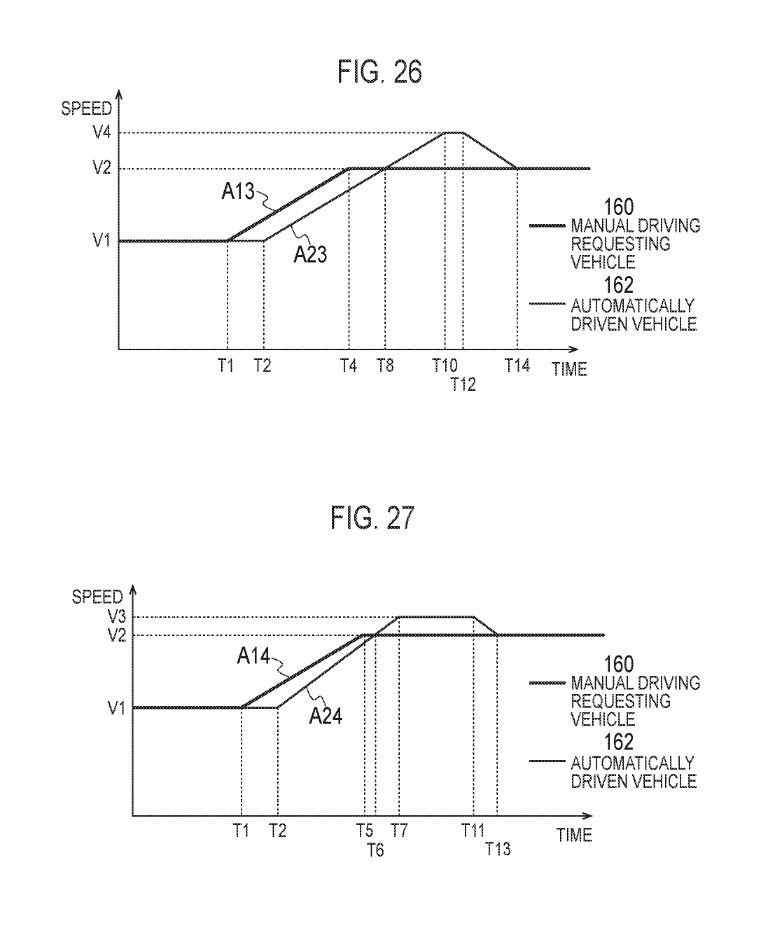

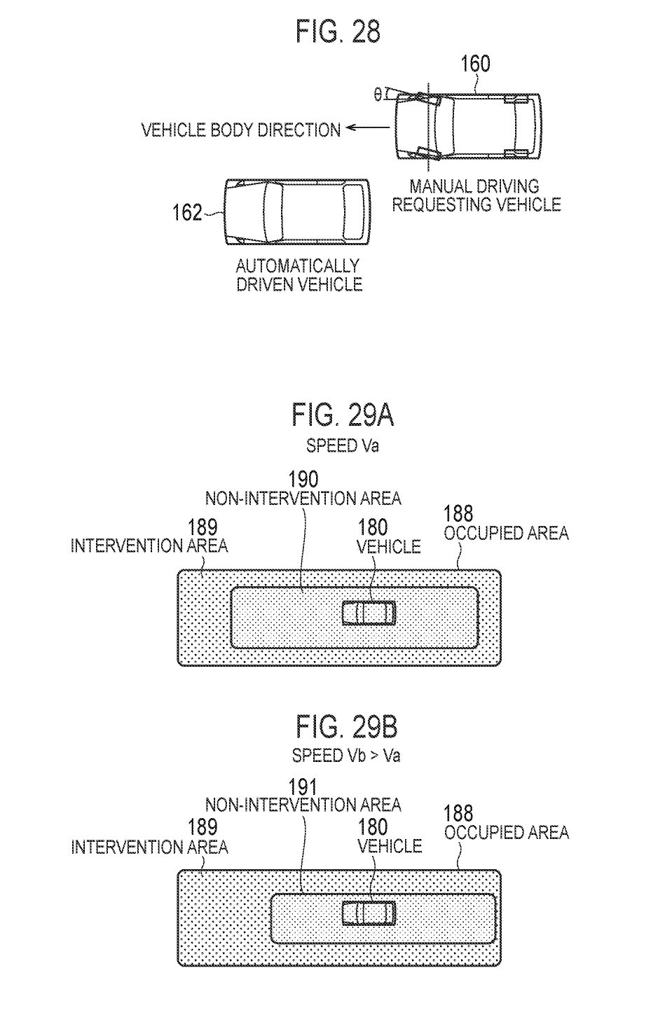

FIG. 26 is a diagram illustrating driving restriction (speed restriction). FIG. 27 is a diagram illustrating driving restriction (acceleration restriction). FIG. 28 is a diagram illustrating driving restriction (actual steering angle restriction). In FIGS. 26 and 27, a vertical axis represents the speed and a horizontal axis represents the time. A thick line indicates the speed change of the manual driving requesting vehicle 160, and the speed is increased from a speed V1 to a speed V2. A thin line indicates the speed change of the automatically driven vehicle 162, and the speed is lowered to a speed V2 after increasing from a speed V1 to a speed V4 or a speed V3.

As illustrated in FIG. 26, it is assumed that the maximum speed of the manual driving requesting vehicle 160 is limited to V2. The manual driving requesting vehicle 160 moving at the speed V1 accelerates at the acceleration A13 at the time T1 and stops the acceleration when reaching the speed V2 at the time T4. Based on the acceleration at the time T1, the automatically driven vehicle 162 is accelerated at the acceleration A23 at the time T2 as much as the delay of the instruction delay time. The automatically driven vehicle 162 reaches the speed V2 at time T8 after the time T4. Even after reaching the speed V2, the acceleration A23 is maintained, the speed reaches the speed V4 at the time T10, and the acceleration is stopped. The deceleration is started at time T12, and at time T14, the speed drops to the same speed V2 as the speed of the manual driving requesting vehicle. The inter-vehicular distance between the manual driving requesting vehicle 160 and the automatically driven vehicle 162 at the time T1 is the shortest distance at time T8. Since the maximum speed of the manual driving requesting vehicle 160 is set to be slower than the maximum speed of the automatically driven vehicle 162, the automatically driven vehicle 162 can travel at a faster speed, thereby returning to the same inter-vehicular distance as the time T1 at the time T14.

As illustrated in FIG. 27, it is assumed that the maximum acceleration of the manual driving requesting vehicle 160 is limited to A14. The manual driving requesting vehicle 160 moving at the speed V1 accelerates at the acceleration A14 at the time T1 and stops the acceleration when reaching the speed V2 at the time T5. Based on the acceleration at the time T1, the automatically driven vehicle 162 is accelerated at the acceleration A24 at the time T2 as much as the delay of the instruction delay time. The automatically driven vehicle 162 reaches the speed V2 at time T6 after the time T5. Even after reaching the speed V2, the acceleration A24 is maintained, the speed reaches the speed V3 at the time T7, and the acceleration is stopped. The deceleration is started at time T11, and at time T13, the speed drops to the same speed V2 as the speed of the manual driving requesting vehicle 160. The inter-vehicular distance between the manual driving requesting vehicle 160 and the automatically driven vehicle 162 at the time T1 is the shortest distance at time T6. Since the maximum speed of the manual driving requesting vehicle 160 is set to be slower than the maximum speed of the automatically driven vehicle 162, the automatically driven vehicle 162 can travel at a faster speed, thereby returning to the same inter-vehicular distance as the time T1 at the time T13. Since the maximum acceleration of the manual driving requesting vehicle 160 is set to be lower than the maximum acceleration of the automatically driven vehicle 162, the automatically driven vehicle 162 can catch up with the speed of the manual driving requesting vehicle in a short time, and as a result, it is possible to shorten the time to restore the inter-vehicular distance to the original distance.

As illustrated in FIG. 28, the angle in the direction of the tire with respect to the front (vehicle body direction) in the vehicle longitudinal direction is set as the actual steering angle (θ). It is assumed that the state in which the direction that the tire faces matches the direction of the vehicle body is set as 0°, a case where the tire faces the right side is set as plus, and a case where the tire faces the left side is set as minus. If the road on which the vehicle travels is limited with respect to the traveling position of the vehicle, the actual steering angle is limited based on the position of the vehicle, the direction of the vehicle body, the speed, and the acceleration. For example, if the automatically driven vehicle 162 travels to the left front of the manual driving requesting vehicle 160 and determines that the manual driving requesting vehicle 160 should not move toward the automatically driven vehicle 162, the limit of the actual steering angle is set to θ=[0, θ1] under this situation. Since the direction of the manual driving requesting vehicle 160 is the same as the direction of the automatically driven vehicle 162 and the automatically driven vehicle 162 travels on the left side of the lane of the manual driving requesting vehicle 160, the angle at which the actual steering angle is minus (the angle on the left side with respect to the vehicle body direction) is limited. Therefore, there is no way toward the automatically driven vehicle 162.

(Area Restriction)

FIGS. 29A to 29B are diagrams illustrating area restriction. FIG. 29A illustrates a case where the speed of the manual driving requesting vehicle 180 is Va, and FIG. 29B illustrates a case where the speed of the manual driving requesting vehicle 180 is Vb (>Va). A dark shaded area is the intervention area. A thin shaded area is a non-intervention area.

As illustrated in FIG. 29A, the manual driving requesting vehicle 180 travels at the speed Va in the occupied area 188. The manual driving requesting vehicle 180 can freely travel the non-intervention area 190 of the manual driving requesting vehicle 180 by manual driving. Since the manual driving requesting vehicle 180 does not leave the occupied area 188 with respect to the manual driving within the intervention area 189, the automatic driving control unit 110 intervenes in the control such as the deceleration, the acceleration, the actual steering angle, and the like.

As illustrated in FIG. 29B, the manual driving requesting vehicle 180 travels at a faster speed Vb than the case of FIG. 29A in the occupied area 188. As the speed is increased, the non-intervention area 191 becomes narrower with respect to the vehicle body direction (the front of the vehicle) as compared with the case of FIG. 29A, and is wider than the direction opposite to the vehicle body direction (the rear of the vehicle). When looking at the front, it is necessary to intervene earlier and decelerate as compared with FIG. 29A so as to perform control not to leave the occupied area 188 by the increased speed of the manual driving requesting vehicle 180. Therefore, it is necessary to widen the front intervention area. On the other hand, when looking at the front, it is necessary to intervene slowly and accelerate as compared with FIG. 29A so as to perform control not to leave the occupied area 188 by the increased speed of the manual driving requesting vehicle 180. Therefore, the rear intervention area may be narrow. The intervention area and the non-intervention area are set according to the position in the occupied area 188 of the manual driving requesting vehicle 180, the direction of the vehicle body, the speed, the acceleration, and the actual steering angle. Therefore, the manual driving can be performed without leaving the occupied area 188.

### EXAMPLES

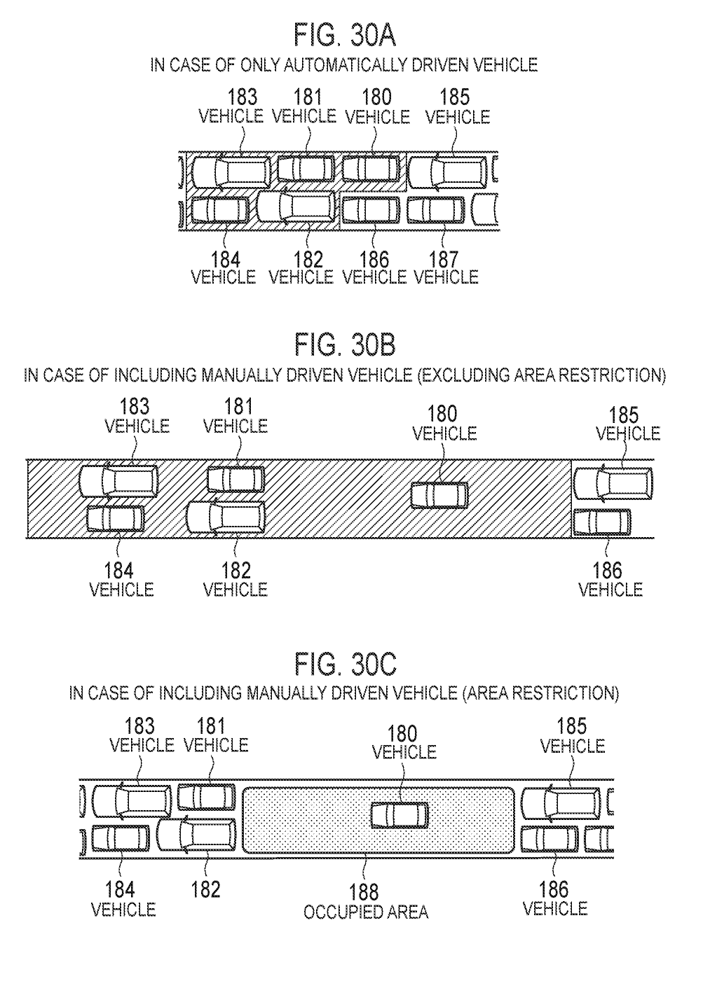

FIGS. 30A to 30C illustrate examples. FIG. 30A illustrates a case where only an automatically driven vehicle is present. FIG. 30B illustrates a case including a manually driven vehicle (excluding area restriction). FIG. 30C illustrates a case including a manually driven vehicle (area restriction).

As illustrated in FIG. 30A, all of the vehicles travel by automatic driving. Automatically driven vehicles 180 to 187 travel based on the route assignment information generated by the route assignment server 200. Based on the occupied area required by individual vehicles, it is possible to run on the road while keeping the vehicle interval.

As illustrated in FIG. 30B, the manual driving requesting vehicle 180 travels by manual driving. Driving information such as the position, the speed, the acceleration, the actual steering angle, the vehicle body direction, and the like of the manual driving requesting vehicle 180 is always notified to the route assignment server 200 through the secured occupied communication path as the vehicle information notification. Based on the vehicle information notification of the manual driving requesting vehicle 180, the route assignment server 200 performs road assignment processing of the surrounding vehicles, generates route assignment information, and transmit the route assignment information to each automatically driven vehicle. The route assignment server 200 performs road assignment of each vehicle with respect to the speed, acceleration, and actual steering angle when the driving is basically restricted as the travel setting, so that the contact with the manual driving requesting vehicle 180 does not occur. The speed, the acceleration, and the actual steering angle used upon the road assignment may be set differently depending on the travel setting. The vehicle distance between the manual driving requesting vehicle 180 and the nearby vehicles 181, 182, 185, and 186 is derived based on the time required from the timing of the change in the driving of the manual driving requesting vehicle 180 to the change of the travel control of the vehicles 181, 182, 185, and 186 corresponding to the change. In order to enable traveling according to the traveling of the manual driving requesting vehicle 180, the vehicle distance is widely taken, and the vehicle travels with sparsely arranged on the road and travel.

As illustrated in FIG. 30C, the manual driving requesting vehicle 180 travels in the occupied area 188 by manual driving. The automatically driven vehicles 181 to 186 travel outside the occupied area 188 of the manual driving requesting vehicle 180. Regardless of the manual driving of the manual driving requesting vehicle 180, the occupied area 188 is generated by the route assignment server 200 in the same manner as the occupied area of the automatically driven vehicles 181 to 186. In the manual driving in the manual driving requesting vehicle 180, if there is a possibility that the manual driving requesting vehicle 180 will go out of the occupied area 188, the automatic driving processing unit 110 of the manual driving requesting vehicle 180 intervenes in the travel control so as not to leave to the occupied area 188. The travel of the manual driving requesting vehicle 180 is limited to the occupied area 188. Therefore, in the automatically driven vehicles 181 to 186 around the manual driving requesting vehicle 180, it is unnecessary to secure the distance between vehicles accompanying the manual driving of the manual driving requesting vehicle 180 and travel in the same vehicle distance as in the case of only the automatically driven vehicle.

The area of the road spread by the manual driving requesting vehicle 180 switching from automatic driving to manual driving is an area in which payment obligation occurs as the charging for the manual driving requesting vehicle 180. For example, a case where the travel setting is the area restriction (FIG. 30C) is the portion of the occupied area 188 of the manual driving requesting vehicle 180 spread by switching from the automatic driving (FIG. 30A). This amount is charged every minute period. On the other hand, a case where the travel setting in the manual driving is not the area restriction (FIG. 30B) is the portion spread by switching from the automatic driving (FIG. 30A). For example, as the part of the area to be charged, when looking at the change in the area where the vehicles 180 to 184 are located in FIGS. 30A and 30B, a road area (shaded area) from a position including the inter-vehicular distance between the vehicles 183 and 184 and the preceding vehicle to a position including the inter-vehicular distance between the vehicles 180 and 182 and the following vehicle in FIG. 30A is spread in the road area (shaded area) from a position including the inter-vehicular distance between the vehicles 183 and 184 and the preceding vehicle to a position including the inter-vehicular distance between the vehicle 180 and the following vehicle in FIG. 30B. This spread is subject to charging. The route assignment server 200 derives the spread road area and requests payment for the widened road area from the charging destination linked with the manual driving of the manual driving requesting vehicle 180 for each minute period. Regarding damage such as accidents caused by the traveling of the manual driving requesting vehicle 180, the charging destination linked with the manual driving of the manual driving requesting vehicle 180 is requested. On the other hand, damage such as accidents in the automatically driven vehicle is self-paid.

(Flow When Emergency Vehicle Approaches)

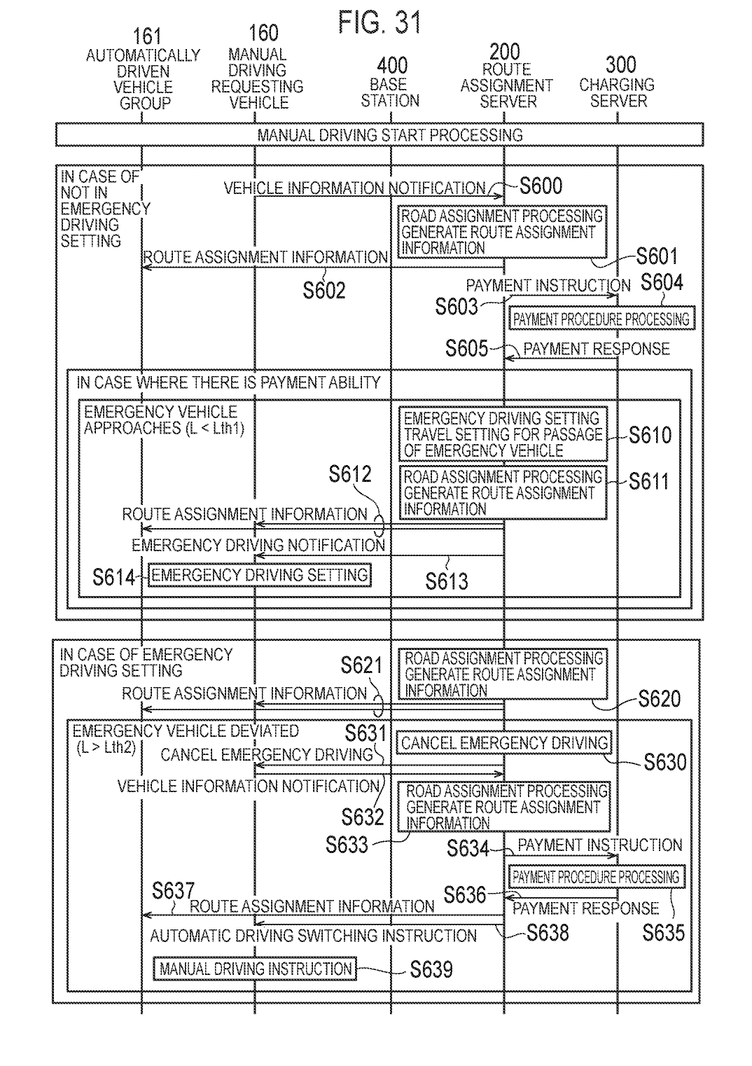

FIG. 31 is a diagram illustrating an example of a flow when an emergency vehicle approaches. If there is an emergency vehicle in the vicinity of the manual driving requesting vehicle, the manual driving requesting vehicle is set to the emergency driving setting.

As illustrated in FIG. 31, in a state in which the manual driving requesting vehicle 160 is in the manual driving, if the manual driving requesting vehicle 160 is not in the emergency driving setting, the manual driving requesting vehicle 160 transmits the vehicle information notification to the route assignment server 200 (step S600). The route assignment server 200 performs road assignment processing and generates route assignment information (step S601). The route assignment server 200 transmits the route assignment information to the automatically driven vehicle group 161 (step S602). Based on the result of the road assignment processing, the route assignment server 200 calculates a payment request amount to the manual driving requesting vehicle 160 and transmits a payment instruction to the charging server 300 (step S603). The charging server 300 receives the payment instruction and performs payment procedure processing to the charging destination associated with the manual driving requesting vehicle 160 (step S604). The charging server 300 notifies a payment response to the route assignment server 200 (step S605).

The route assignment server 200 determines whether the manual driving requesting vehicle 160 is close to the emergency vehicle, based on the vehicle position measurement value of the vehicle information notification and the driving information such as the speed, the acceleration, the actual steering angle, the vehicle body direction, and the like in the driving control. For example, if the distance between the manual driving requesting vehicle 160 and the emergency vehicle is L and a threshold value determined to be close is Lth1, it is determined that the vehicle is close to the emergency vehicle when L<Lth1. If it is determined that the emergency vehicle is closely present, the route assignment server 200 sets the emergency driving setting (that is, the movement setting of “emergency movement”) to the manual driving requesting vehicle 160 in a manual driving state (step S610). The route assignment server 200 performs the road assignment processing of the manual driving requesting vehicle 160 together with the automatically driven vehicle group 161 and generates route assignment information (step S611). The route assignment server 200 transmits the route assignment information (step S612). The route assignment server 200 transmits an emergency driving notification to the manual driving requesting vehicle 160 (step S613). The output unit 104 of the manual driving requesting vehicle 160 outputs the emergency driving setting to the passenger (step S614). After that, the manual driving requesting vehicle 160 becomes the emergency driving setting and becomes the automatic driving like the automatically driven vehicle group 161.

If the manual driving requesting vehicle 160 is in the emergency driving setting, the route assignment server 200 performs the road assignment processing of the automatically driven vehicle group 161 and the manual driving requesting vehicle 160 of the emergency driving setting, and generates the route assignment information (step S620). The route assignment server 200 transmits the route assignment information (step S621). The route assignment server 200 determines whether the emergency vehicle has moved away from the manual driving requesting vehicle 160. For example, if the distance between the manual driving requesting vehicle 160 and the emergency vehicle is L and a threshold value determined to be close is Lth2, it is determined that the vehicle has moved away if L>Lth2. If it is determined that the emergency vehicle has moved away, the route assignment server 200 cancels the emergency driving setting for the manual driving requesting vehicle 160 set as the emergency driving setting (step S630). The route assignment server 200 transmits an emergency driving cancellation to the manual driving requesting vehicle 160 that is the target of the emergency driving cancellation (step S631). During the manual driving, the manual driving requesting vehicle 160 always transmits the vehicle information notification to the route assignment server 200 (step S632). On the assumption that the manual driving requesting vehicle 160 switches to manual driving, the route assignment server 200 performs road assignment processing of the automatically driven vehicle group 161 and generates route assignment information (step S633). Based on the result of the road assignment processing, the route assignment server 200 calculates a payment request amount to the manual driving requesting vehicle 160 and transmits a payment instruction to the charging server 300 (step S634). The charging server 300 receives the payment instruction and performs payment procedure processing to the charging destination associated with the manual driving requesting vehicle 160 (step S635). The charging server 300 notifies a payment response to the route assignment server 200 (step S636). The route assignment server 200 transmits the route assignment information to the automatically driven vehicle group 161 (step S637). The route assignment server 200 transmits an automatic driving switching instruction to the manual driving requesting vehicle 160 (step S638). Based on reception of the automatic driving switching instruction, the manual driving requesting vehicle 160 outputs a manual driving instruction to the passenger (step S639).

(Visual Recognition Unnecessary Processing Flow)

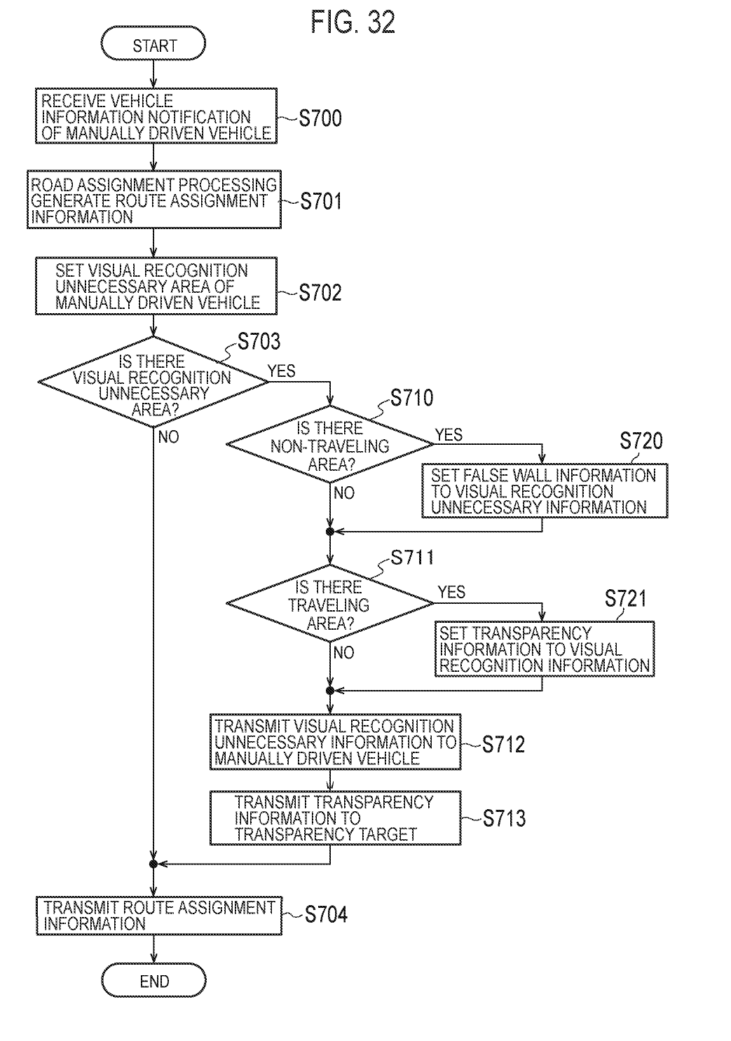

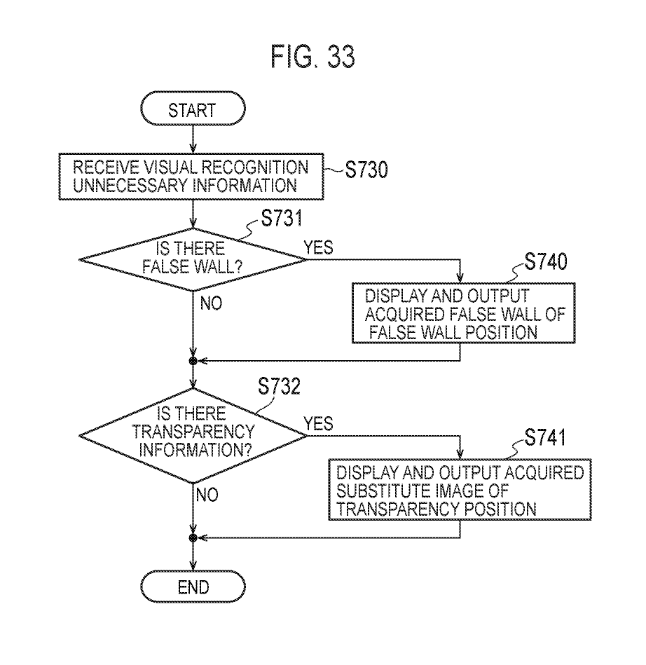

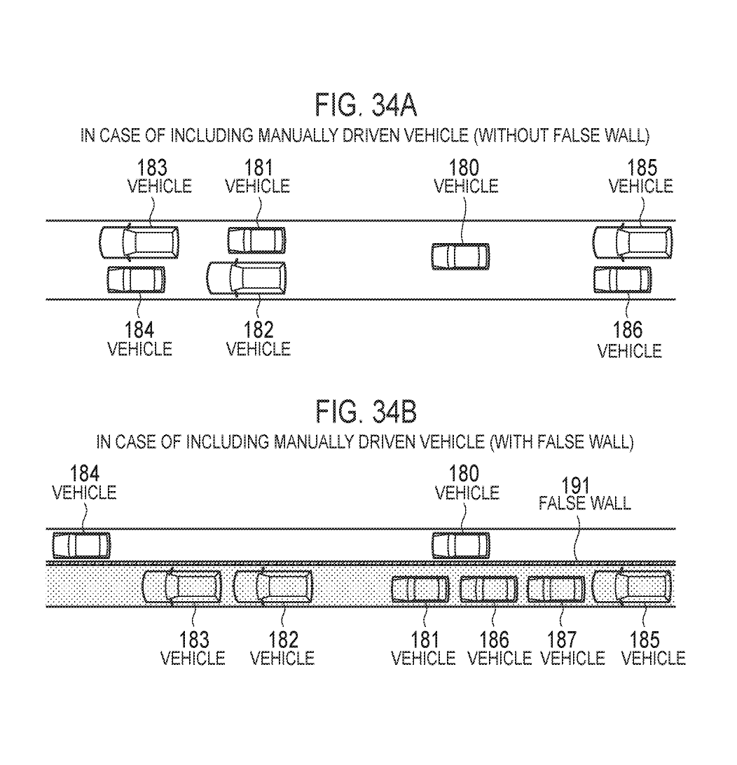

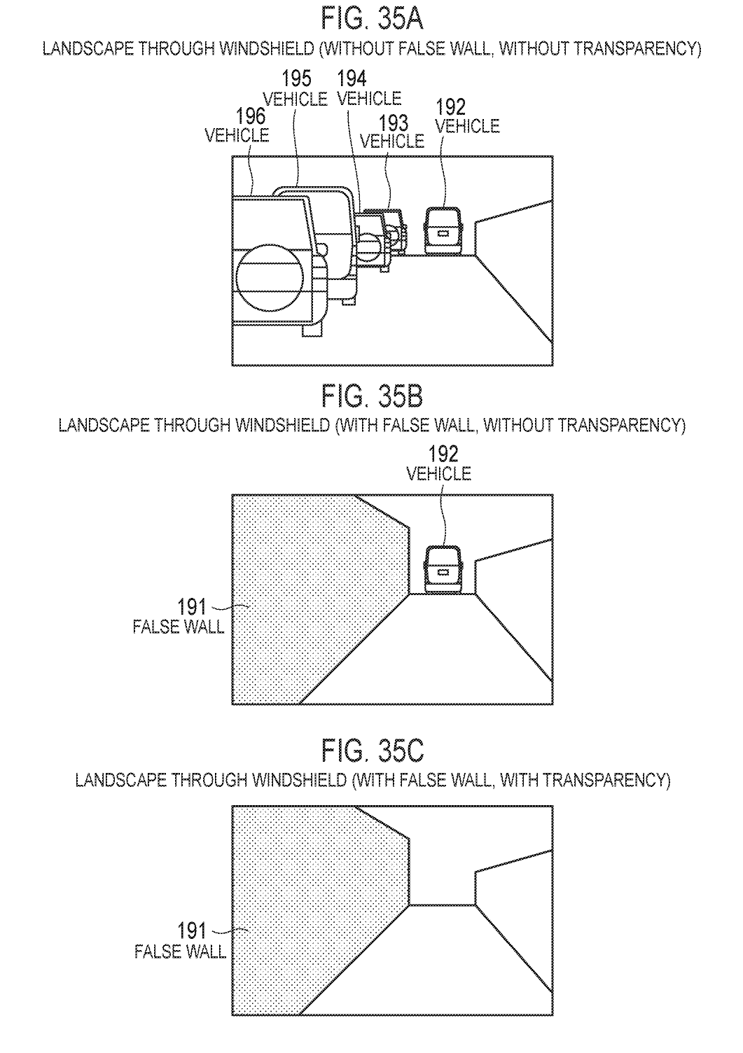

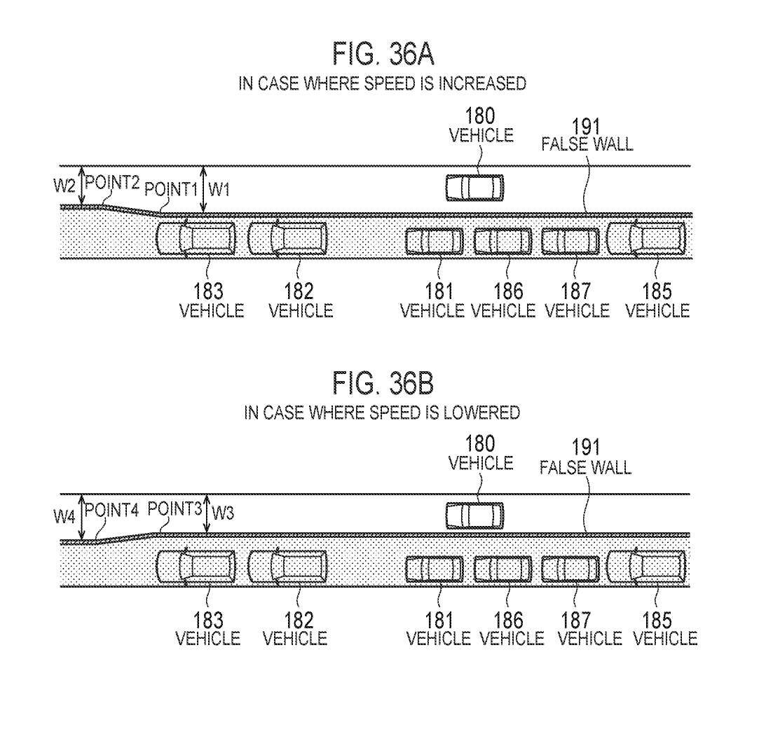

FIG. 32 illustrates an example of a flowchart of the route assignment server 200 that performs visual recognition unnecessary processing. FIG. 33 illustrates an example of a flowchart of the manually driven vehicle of the visual recognition unnecessary processing. FIG. 34 is a diagram illustrating the visual recognition unnecessary processing. FIG. 35 illustrates an example of the visual recognition unnecessary processing. FIG. 36 illustrates an example of the arrangement of false walls.

As illustrated in FIG. 32, the route assignment server 200 receives the vehicle information notification from the manually driven vehicle (the manual driving requesting vehicle 160) (step S700). The route assignment server 200 performs road assignment processing based on the received vehicle information notification and generates route assignment information (step S701). Based on the route assignment information, the route assignment server 200 determines whether there is a portion which need not be visually recognized in the driving of the manually driven vehicle, and sets a visual recognition unnecessary area with respect to the portion determined to be unnecessary (step S702).

If there is the visual recognition unnecessary area (step S703: Yes), the route assignment server 200 determines whether the visual recognition-impossible area is a non-traveling area for the manually driven vehicle (step S710). In the case of the non-traveling area (step S710: Yes), the route assignment server 200 sets the visual recognition unnecessary area, which is the non-traveling area, to visual recognition-impossible information as false wall information (step S720).

In addition, the route assignment server 200 determines whether the visual recognition unnecessary area is a traveling area for the manually driven vehicle (step S711). In the case of the traveling area (step S711: Yes), the route assignment server 200 sets the visual recognition unnecessary area, which is the traveling area, to visual recognition-impossible information as transparency information (step S721). The route assignment server 200 transmits the visual recognition unnecessary information to the manually driven vehicle (step S712), transmits the transparency information to a transparency target (step S713), and transmits the route assignment information to the vehicle (step S704).

The false wall information includes a geographical position, a height, a texture, or the like of a wall which constitutes the false wall. The transparency information includes identification information, a position, and a speed of the transparency target (vehicle), a direction and size of an image acquired by the sensor of the transparency target, and the communication path used for transmitting the acquired image to the manually driven vehicle. Upon receiving the transparency information from the route assignment server 200, the vehicle (the vehicle 100 and the manual driving requesting vehicle 160) which is the transparency target acquire an image according to the transparency information and transmits the acquired image by using a communication path indicated by the transparency information.

As illustrated in FIG. 33, the manually driven vehicle (the manual driving requesting vehicle 160) receives the visual recognition unnecessary information (step S730), and confirms whether the false wall information is set in the visual recognition unnecessary information (step S731). If the false wall information is set (step S731: Yes), the manually driven vehicle acquires the false wall information and displays and outputs the false wall on the vision (field of view) from the driver based on the false wall information (step S740). Furthermore, the manually driven vehicle confirms whether the transparency information is set to the visual recognition unnecessary information (step S732). If the transparency information is set (step S732: Yes), the manually driven vehicle acquires the transparency information, generates a substitute image based on the transparency information, and displays and outputs the substitute image on the vision (field of vision) from the driver (step S741). The substitute image is formed from the image received through the communication path indicated by the transparency information, based on the shape, distance, or the like on the line of sight of the transparency target having transmitted the image.

In FIGS. 34A to 34B, the vehicle 180 is assumed to be a manually driven vehicle. The vehicles 181 to 187 are automatically driven vehicles. FIG. 34A illustrates a case where there is no false wall. For the vehicle 180, the vehicles 181 to 186 travel while taking the vehicular distance. When the vehicle 180 increases the speed, the vehicles 181 to 184 traveling in front of the vehicle 180 are speeded up so as not to contact the vehicle 180.

FIG. 34B illustrates a case where there is a false wall. The vehicles 181 to 183 and 185 to 187 travel on the left side of the road. On the other hand, the vehicles 180 and 184 travel on the right side of the road. The route assignment server 200 sets the traveling place (shaded area) of the vehicles 181 to 183 and 185 to 187 as the non-traveling area of the vehicle 180 and sets the false wall 191 between the vehicle 180 and the non-traveling area. As the vehicle 180 increases the speed, the vehicle 184 traveling in front of the vehicle 180 speeds up so as not to contact the vehicle 180, or enters the front of the vehicle 183 which is the non-traveling area of the vehicle 180.

If entering the non-traveling area from the traveling area, the vehicle 184 is previously set as a visual recognition unnecessary area and transmits a front image (image in the direction from the vehicle 180 to the vehicle 184) acquired by the sensor to the vehicle 180. The vehicle 180 generates the substitute image based on the image and displays and outputs the substitute image on the line of sight from the driver, instead of the vehicle 184. As a result, the driver of the vehicle 180 travels without worrying about the vehicles 181 to 187. In addition, since it is not possible to recognize that there is room for one vehicle between the vehicle 182 and the vehicle 181, it is unlikely that the vehicle 180 will be put in a vacancy.

If the driver wears a head mounted display or the like and views the surrounding landscape through the head mounted display, the false wall image is displayed and output at an appropriate position based on the direction of the head of the driver, the direction of the line of sight, the direction and distance of the false wall, the direction and distance of the transparency target, and the substitute image is displayed and output so as to superimpose the transparency target. Alternatively, if projecting on the windshield, the false wall image is displayed and output at an appropriate position on the windshield based on the driver, the head position, a direction, line of sight direction, a direction and distance of a false wall, a direction and distance of the transparency target, and the substitute image is displayed and output on the windshield so as to superimpose the transparency target.

FIG. 35A to 35C illustrate landscapes that the driver of the manually driven vehicle views through the windshield. FIG. 35A illustrates a case with no false wall and no transparency. FIG. 35B illustrates a case with a false wall and no transparency. FIG. 35C illustrates a case with a false wall and transparency. If the false wall and the transparency are not set (FIG. 35A), the driver of the manually driven vehicle sees the walls on the right side of the vehicles 192 to 196 through the windshield. On the other hand, if the false wall is set (FIG. 35B), the driver of the manually driven vehicle sees the vehicle 192 and the wall (false wall 191) on the left side, through the windshield, in addition to the wall on the right wall. Furthermore, if the transparency is set (FIG. 35C), the driver of the manually driven vehicle sees the right wall and the left wall (false wall 191) through the windshield. In addition, at this time, the right wall is a false wall and the oncoming vehicle may travel beyond the false wall.

The driver of the manually driven vehicle will concentrate on only the empty road ahead without worrying about the vehicle behind the false wall. In addition, in the road assignment processing for the automatically driven vehicle positioned across the false wall, it is unnecessary to worry about the tendency of the manually driven vehicle. That is, even if the speed of the manually driven vehicle increases, there is no need to increase the speed of the automatically driven vehicle accordingly. If the vehicle 192 is the transparency target, the route assignment server 200 can evacuate the vehicle 192 from the front of traveling of the manually driven vehicle beyond the false wall with the speed increase of the manually driven vehicle as the route assignment. On the contrary, when the vehicle 192 is moved beyond the false wall in a state of not being the transparency target, the driver of the manual driving vehicle recognizes that the vehicle 192 traveling in front superimposes the false wall and disappears into the false wall, and there is a possibility of causing a feeling of intentionally bringing the vehicle closer to the false wall.

If a plurality of transparency targets (vehicles) superimpose one another, each target individually acquires image information that is the direction of the line of sight of the driver of the manually driven vehicle and notifies the manually driven vehicle of the acquired image information. In contrast, in the manually driven vehicle, image information from the transparency object on the line of sight of the driver is superimposed and reconstructed. For example, the image acquired from the transparency target farthest from the line of sight is displayed according to the farthest transparency target. In the parts other than the part displaying the image, the image acquired from the transparency target next farther from the line of sight is displayed according to the next transparency target which is far away. This is repeated until the nearest transparency object. Therefore, even when a plurality of transparency targets superimpose one another, it is possible to make all appear transparent.

If the driver of the manually driven vehicle brings the vehicle into contact with the false wall, the automatic/manual switching unit 116 of the manually driven vehicle permits partial or all intervention into the driving of the automatic driving processing unit 110. The automatic driving processing unit 110 controls the driving by pseudo contact with the false wall, and performs the travel control so that the manually driven vehicle moves away from the false wall.

FIG. 36A illustrates an example of a case where the manually driven vehicle 180 increases the speed. FIG. 36B illustrates an example of a case where the manually driven vehicle 180 lowers the speed. As illustrated in FIG. 36A, if the manually driven vehicle 180 increases the speed, the road width becomes narrower from the traveling destination point 1 with respect to the current road width W1, and after the point 2, the road width becomes W2. As illustrated in FIG. 36B, if the manually driven vehicle 180 lowers the speed, the road width becomes wider from the traveling destination point 3 with respect to the current road width W3, and after the point 4, the road width becomes W4. In the case of narrowing the road width of the traveling area, it shall not be narrower than the road width that can be traveled by the skill of the driver of the manually driven vehicle 180 with respect to the speed of the vehicle and the condition of the road. In the case of widening the road width of the traveling area, the vehicle hidden by the false wall shall be limited to the place where the minimum control margin can be secured, at least to the extent of not protruding from the false wall, or so as to prevent actual contact with the automatically driven vehicle at the end of the false wall when the manually driven vehicle 180 contacts the false wall. The speed of the manually driven vehicle 180 can be controlled indirectly by changing the road width of the traveling area of the manually driven vehicle 180.

(Manual Driving Determination Flow by Traveling Area)

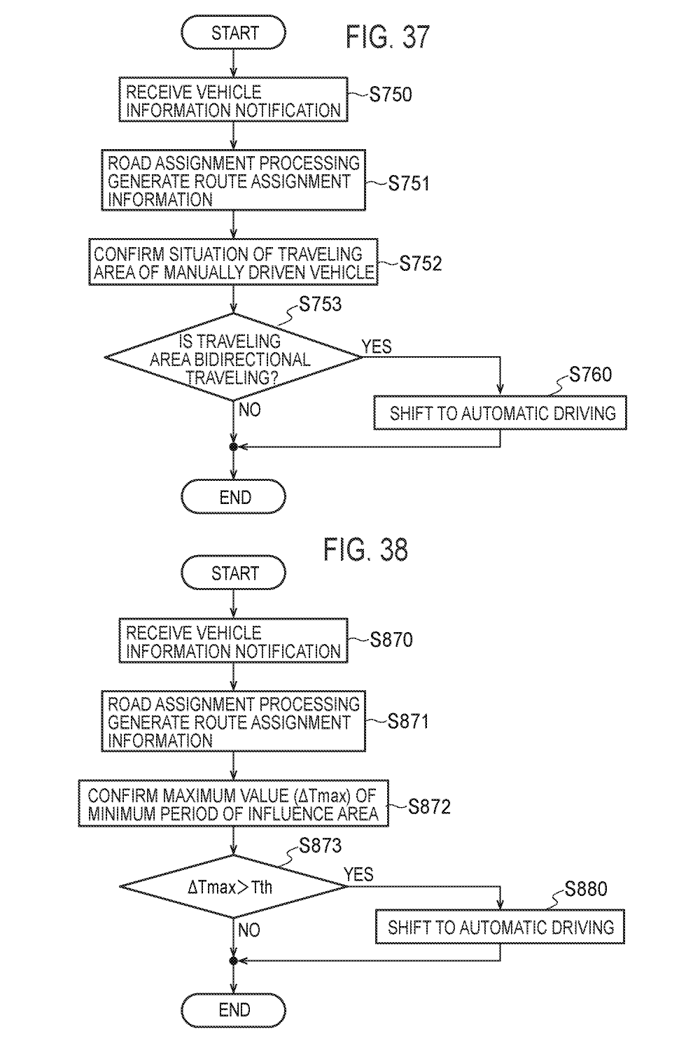

FIG. 37 is a diagram illustrating a manual driving determination flow by traveling area.

As illustrated in FIG. 37, the route assignment server 200 receives the vehicle information notification from the manually driven vehicle (step S750). The route assignment server 200 performs road assignment processing based on the received vehicle information notification and generates route assignment information (step S751). Based on the route assignment information, the route assignment server 200 confirms the situation of the traveling area of the manually driven vehicle (step S752). As a result of the confirmation, if the traveling area is bidirectional traveling, in other words, if there is a vehicle traveling to face the vehicle in the traveling area (step S753: Yes), the route assignment server 200 instructs the automatic driving (step S760). Therefore, if it is determined that it is difficult to avoid the oncoming vehicle against the approach of the manually driven vehicle, the risk of contact is avoided by shifting the manually driven vehicle to the automatic driving. By separating the oncoming automatically driven vehicle from the traveling area into the non-traveling area by the visual recognition unnecessary processing, the manually driven vehicle can travel without shifting to the automatic driving.

(Manual Driving Determination Flow by Minute Period)

FIG. 38 is a diagram illustrating a manual driving determination flow by a minute period.

As illustrated in FIG. 38, the route assignment server 200 receives the vehicle information notification from the manually driven vehicle (step S870). The route assignment server 200 performs road assignment processing based on the received vehicle information notification and generates route assignment information (step S851). The route assignment server 200 acquires the route assignment information of the automatically driven vehicle, of which the traveling is affected by the presence of the manually driven vehicle. Based on the acquired route assignment information of the automatically driven vehicle, the route assignment server 200 acquires a maximum value (ΔTmax) of the minute period at the position of the automatically driven vehicle (step S872), and if the maximum value (ΔTmax) is larger than a threshold value (Tth) (step S873: Yes), the route assignment server 200 instructs the manually driven vehicle to shift to automatic driving (step S880). In other words, if there is a vehicle traveling on a route which cannot be immediately responded while the manually driven vehicle has changed the traveling such as increasing the speed, the manually driven vehicle is shifted to the automatic driving. This avoids the risk of contact that occurs because the automatically driven vehicle cannot respond quickly.

[Supplementary Note]

A transportation system includes a first vehicle that is connected to communicate with a network in radio communication and performs automatic driving, a second vehicle that is connected to communicate with the network in radio communication and manually driven by a passenger, and a route assignment server that is connected to communicate with the vehicle through the network and calculates a traveling route of the vehicle. The route assignment server performs the assignment of the road area occupied by the vehicle every minute time period to the destination of the first vehicle, based a destination from the first vehicle, vehicle information from the first vehicle, road information, vehicle information from the second vehicle, and driving information of the second vehicle, and the first vehicle performs automatic driving based on the assignment of the road area.

The driving information includes a position, a speed, an acceleration, an actual steering angle, and a vehicle body direction of the vehicle.

The second vehicle includes a manual driving unit that drives a vehicle based on a manual driving by a passenger, an automatic driving unit that drives a vehicle according to an instruction of the route assignment server, and a switching unit that controls a degree of dependency between the manual driving unit and the automatic driving unit with respect to driving of the vehicle according to the instruction of the route assignment server.

If there is a vehicle that desires manual driving, when the vehicle that desires the manual driving travels by manual driving, the route assignment server requests a base station or a base station control server to secure an occupied communication path according to communication capacity to be performed.

The route assignment server does not permit the manual driving if securing the occupied communication route as requested is not confirmed.

The route assignment server requests a payment source associated with the vehicle desiring the manual driving to pay for consideration for securing the occupied communication path, and if the payment cannot be confirmed, the route assignment server does not permit the manual driving.

In a case where there is a vehicle that desires manual driving, when the vehicle that desires the manual driving travels by manual driving, the route assignment server requests the payment source associated with the vehicle desiring the manual driving to pay for the road space secured by the automatically driven vehicle, and if the payment cannot be confirmed, the route assignment server does not permit the manual driving.

In a case where there is a vehicle that desires manual driving, the route assignment server does not permit manual driving if the driving qualification of the driver who desires the manual driving is not confirmed.

In a case where there is a vehicle that desires manual driving, the route assignment server does not permit manual driving if either one of the insurance associated with the vehicle that desires the manual driving and the insurance associated with the driver who desires the manual driving cannot be confirmed or neither one of them can be confirmed.

In a case where there is a vehicle that desires manual driving, the route assignment server does not permit manual driving if the physical information of the driver who desires the manual driving is not confirmed.

In a case where there is a vehicle that desires manual driving, the route assignment server instructs automatic driving if it is determined that there is a problem in continuing the driving based on the physical information of the driver who desires the manual driving.

The second vehicle includes a manual driving unit that is directly operated by a driver when the driving control of the second vehicle is manually performed, and a body measurement unit that is attached to the body of the passenger, measures a condition of the body, and communicates with the manual driving unit. At the start of the manual driving by the driver and during the manual driving, the manual driving unit acquires the information held by the body measurement unit from the body measurement unit and notifies the route assignment server of the acquired information.

The information held by the body measurement unit is a measurement value.

The information held by the body measurement unit is a disease history.

The information held by the body measurement unit is personal identification information.

The information held by the body measurement unit is identification information of the body measurement unit.

The body measurement unit is a device arranged in the driver's blood.

In a case where there is a vehicle that performs manual driving, if the route assignment server determines that an emergency vehicle exists near the vehicle that performs the manual driving, based on the driving information of the vehicle that performs the manual driving and the route assignment information of the emergency vehicle, the route assignment server instructs the automatic driving to the vehicle that performs the manual driving.

In a case where there is a vehicle that performs manual driving, if the route assignment server determines that the vehicle that performs the manual driving exists in or around the emergency area, based on the driving information of the vehicle that performs the manual driving and the weather information, the route assignment server instructs the automatic driving to the vehicle that performs the manual driving.

In a case where there is a vehicle that performs manual driving, if the route assignment server determines that the risk of accident occurrence is high, based on the driving information of the vehicle that performs the manual driving, the route assignment server cancels the permission of the manual driving to the vehicle that performs the manual driving.

The route assignment server performs notification of assignment of road areas occupied by each calculated vehicle according to driving information of the vehicle that performs the manual driving by using the secured occupied communication path.

In a case where there is a vehicle that performs manual driving, if the route assignment server determines that there is a portion unnecessary to be visually recognized by the driver who performs the manual driving, the route assignment server notifies information about the portion unnecessary to be visually recognized to the vehicle that performs the manual driving.

The vehicle that performs the manual driving displays and outputs a corresponding image on the line of sight of the driver who performs the manual driving, based on the information about the portion unnecessary to be visually recognized.

If the portion unnecessary to be visually recognized is the traveling prohibited area of the vehicle that performs the manual driving, a wall is displayed and output as an image that is displayed and output on the line of sight of the driver.

If the portion unnecessary to be visually recognized is a vehicle that performs automatic driving of the travelable area of the vehicle that performs the manual driving, a hidden image in the vehicle that performs the automatic driving is displayed and output as an image that is displayed on the line of sight of the driver.

According to the instruction of the route assignment server, the vehicle that performs the automatic driving transmits the image including the captured hidden image to the vehicle that performs the manual deriving by using the secured occupied communication path.

According to a speed of the vehicle that performs the manual driving, a display output position of the wall is changed and a road width of the visible traveling area is changed.

In a case where there is a vehicle that performs manual driving, if the route assignment server determines that the oncoming vehicle is present in the traveling area of the vehicle that performs the manual driving, the route assignment server instructs the automatic driving to the vehicle that performs the manual driving.

In a case where there is a vehicle that desires manual driving, the route assignment server does not permit the manual driving if the synchronization accuracy of the position and surroundings is low, based on the position from the vehicle.

### INDUSTRIAL APPLICABILITY

The present invention is useful in road transportation systems.

1. A server device performing communication with a plurality of vehicles through a network, the server device comprising a processor, wherein
the processor is configured to:
if the plurality of vehicles include a first vehicle traveling by automatic driving and a second vehicle traveling by manual driving, acquire driving information of the second vehicle, and
assign, to the first vehicle, a road area to which the first vehicle should travel by the automatic driving, based on the driving information, so that contact between the first vehicle and the second vehicle does not occur.

2. The server device according to claim 1, wherein
the driving information includes at least one of a position, a speed, acceleration, an actual steering angle, and a vehicle body direction of the second vehicle.

3. The server device according to claim 1, wherein
the processor is further configured to determine whether to permit the manual driving to the second vehicle, and
if the processor determines that the manual driving is not permitted, the processor is further configured to instruct automatic driving to the second vehicle.

4. The server device according to claim 3, wherein,
if charging is made for the manual driving, the processor is further configured to inquire of another server device which manages the charging whether it is possible to permit the manual driving to the second vehicle.

5. The server device according to claim 3, wherein
the processor is further configured to inquire of another server device which manages registration information about a driver of the second vehicle whether it is possible to permit the manual driving to the second vehicle, and
the registration information includes information about at least one of driving qualification and insurance.

6. The server device according to claim 3, wherein
the processor is further configured to acquire physical information about a physical condition of a driver of the second vehicle from the second vehicle, and
the processor is further configured to determine whether to permit the manual driving to the second vehicle, based on the physical information.

7. The server device according to claim 3, wherein
the processor is further configured to perform processing for securing a communication resource necessary for communication associated with the manual driving in a base station, and
if securing the communication resource is impossible, the processor is further configured to determine that the manual driving is not permitted to the second vehicle.

8. The server device according to claim 3, wherein
the processor is further configured to determine whether the second vehicle exists in a danger zone, based on weather information about weather and/or the driving information, and
if the processor determines that the second vehicle exists in the danger zone, the processor is further configured to determine that the manual driving is not permitted to the second vehicle.

9. The server device according to claim 3, wherein,
if the first vehicle is an emergency vehicle, the processor determines whether the second vehicle exists in the vicinity of the first vehicle, based on the road area assigned to the first vehicle and the driving information, and
if the processor determines that the second vehicle exists in the vicinity of the first vehicle, the processor is further configured to determine that the manual driving is not permitted to the second vehicle.

10. The server device according to claim 3, wherein
the processor is further configured to determine whether an oncoming vehicle exists in a travelable area of the second vehicle, and
if the processor determines that the oncoming vehicle exists in the travelable area, the processor is further configured to determine that the manual driving is not permitted to the second vehicle.

11. The server device according to claim 3, wherein
the processor is further configured to estimate synchronization accuracy corresponding to a position of the second vehicle, based on the position of the second vehicle, and
if the processor determines that the synchronization accuracy is low, the processor is further configured to determine that the manual driving is not permitted to the second vehicle.

12. The server device according to claim 1, wherein
the processor is further configured to assign, to the second vehicle, a road area that permits traveling by the manual driving, and
the processor is further configured to assign, to the first vehicle, a road area outside the road area assigned to the second vehicle.

13. The server device according to claim 1, wherein,
if an image output unit is provided on the line of sight of a driver of the second vehicle, the processor is further configured to notify the second vehicle of information for causing the image output unit to display an image corresponding to a visual recognition unnecessary area that the driver of the second vehicle does not need to visually recognize.

14. The server device according to claim 13, wherein
the visual recognition unnecessary area is another vehicle that exists in front of the second vehicle, and
the image is a substitute image captured by the other vehicle.

15. The server device according to claim 13, wherein
the visual recognition unnecessary area is a space on a road area where the traveling of the second vehicle is not permitted, and
the image is a mask image for hiding the space.

16. The server device according to claim 15, wherein
the processor is further configured to change a method of displaying the mask image according to a speed of the second vehicle.

17. A vehicle control device provided in a vehicle and controlling the vehicle, the vehicle control device comprising:
a communication unit configured to perform communication with a server device through a network;
a processor configured to notify the server device of driving information of the vehicle if the vehicle travels by manual driving; and
the processor is further configured to restrict traveling by the manual driving, based on an instruction from the server device.

18. The vehicle control device according to claim 17, wherein,
if the manual driving is permitted from the server device, the processor is further configured to the vehicle to travel by the manual driving, and
if an instruction is issued from the server device to perform automatic driving, the processor is further configured to control the vehicle to travel by the automatic driving.

19. The vehicle control device according to claim 17, wherein
the processor is further configured to notify the server device of physical information about a physical condition of a driver of the vehicle.

20. The vehicle control device according to claim 17, further comprising
an image output unit configured to display an image on the line of sight of a driver of the vehicle,
wherein the processor is further configured to perform processing of causing the image output unit to display an image corresponding to a visual recognition unnecessary area that the driver of the vehicle does not need to visually recognize, based on information from the server device.

21. A communication device provided for a vehicle, the communication device comprising:
a communication unit configured to perform communication with a server device through a network,
wherein, if the vehicle travels by the manual driving, the communication unit is further configured to transmit driving information of the vehicle to the server device, and
the communication unit is further configured to receive, from the server device, an instruction for restricting traveling by the manual driving.
